(19) United States
(12) Patent Application Publication
(10) Pub. No.: US 2024/0107526 A1
(43) Pub. Date: Mar. 28, 2024

(54) APPARATUS AND METHOD IN WIRELESS COMMUNICATION SYSTEM

(71) Applicant: Samsung Electronics Co., Ltd., Suwon-si (KR)

(72) Inventors: Sa ZHANG, Beijing (CN); Feifei SUN, Beijing (CN)

(21) Appl. No.: 18/473,724

(22) Filed: Sep. 25, 2023

(30) Foreign Application Priority Data
Sep. 26, 2022 (CN) 202211177259.4

(51) Int. Cl. H04W 72/1268; H04W 72/21

(52) U.S. Cl. CPC H04W 72/1268; H04W 72/21

(57) ABSTRACT

An apparatus in a wireless communication system and a method performed by the same are provided. The method includes determining whether uplink control information (UCI) is multiplexed in a first physical uplink shared channel (PUSCH) including more than one transport block and/or whether the first PUSCH is simultaneously transmitted with a physical uplink control channel (PUCCH) including the UCI, receiving information for scheduling transmission of the first PUSCH, and transmitting the first PUSCH and/or the PUCCH including the UCI based on the determination. The disclosure can improve the communication efficiency.

### CROSS-REFERENCE TO RELATED APPLICATION(S)

This application is based on and claims priority under 35 U.S.C. § 119(a) of a Chinese patent application number 202211177259.4, filed on Sep. 26, 2022, in the Chinese Intellectual Property Office, the disclosure of which is incorporated by reference herein in its entirety.

### BACKGROUND

### 1. Field

The disclosure relates to the technical field of wireless communication. More particularly, the disclosure relates to an apparatus in a wireless communication system and a method performed by the same.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet the increasing demand for wireless data communication services since the deployment of 4^{th} generation (4G) communication systems, efforts have been made to develop improved 5^{th} generation (5G) or pre-5G communication systems. Therefore, 5G or pre-5G communication systems are also called “Beyond 4G networks” or “Post-long term evolution (LTE) systems”.

In order to achieve a higher data rate, 5G communication systems are implemented in higher frequency (millimeter wave (mmWave)) bands, e.g., 60 gigahertz (GHz) bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid frequency shift keying (FSK) and quadrature amplitude modulation (QAM) (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus in a wireless communication system and a method performed by the same.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes determining whether uplink control information (UCI) is multiplexed in a first physical uplink shared channel (PUSCH) including more than one transport block (TB) or whether the first PUSCH is simultaneously transmitted with a physical uplink control channel (PUCCH) including the UCI, receiving information for scheduling transmission of the first PUSCH, and transmitting the first PUSCH or the PUCCH including the UCI based on the determination.

In accordance with another aspect of the disclosure, a terminal in a wireless communication system is provided. The terminal includes a transceiver, and at least one processor coupled to the transceiver and configured to determine whether uplink control information (UCI) is multiplexed in a first physical uplink shared channel (PUSCH) including more than one transport block (TB) or whether the first PUSCH is simultaneously transmitted with a PUCCH including the UCI, receiving information for scheduling transmission of the first PUSCH, and transmitting the first PUSCH or the PUCCH including the UCI based on the determination.

In accordance with another aspect of the disclosure, a base station in a wireless communication system is provided. The base station includes a transceiver, and at least one processor coupled to the transceiver and configured to determine whether UCI can be multiplexed in a first PUSCH including more than one transport block or whether the first PUSCH can be simultaneously transmitted with a PUCCH including the UCI, transmitting information for scheduling transmission of the first PUSCH, and receiving the first PUSCH or the PUCCH including the UCI.

In accordance with another aspect of the disclosure, a computer-readable storage medium having one or more computer programs stored thereon is provided. The one or more computer programs, when executed by one or more processors, can implement any of the above-described methods.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a schematic diagram of an example wireless network according to an embodiment of the disclosure;

FIGS. 2A illustrates an example wireless transmission path according to an embodiment of the disclosure;

FIGS. 2B illustrates an example wireless reception path according to an embodiment of the disclosure;

FIG. 2C illustrates a radio protocol architecture of a next generation mobile communication system according to an embodiment of the disclosure;

FIG. 3A illustrates an example user equipment (UE) according to an embodiment of the disclosure;

FIG. 3B illustrates an example next-generation node B (gNB) according to an embodiment of the disclosure;

FIG. 4 illustrates a block diagram of a second transceiving node according to an embodiment of the disclosure;

FIG. 5 illustrates a flowchart of a method performed by a UE according to an embodiment of the disclosure;

FIGS. 6A, 6B, and 6C illustrate examples of uplink transmission timing according to an embodiment of the disclosure;

FIG. 7 a flowchart of a method performed by a terminal according to an embodiment of the disclosure;

FIG. 8 illustrates a block diagram of a first transceiving node according to an embodiment of the disclosure;

FIG. 9 illustrates a flowchart of a method performed by a base station according to an embodiment of the disclosure; and

FIG. 10 illustrates a flowchart of a method performed by a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Unless otherwise defined, the technical terms or scientific terms used in the disclosure shall have the ordinary meaning understood by those with ordinary skills in the art to which the disclosure belongs.

It should be understood that “first”, “second” and similar words used in the disclosure do not express any order, quantity or importance, but are only used to distinguish different components.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5^{th} generation (5G) systems or new radio (NR) systems, etc. In addition, the technical schemes of the embodiments of the application can be applied to future-oriented communication technologies.

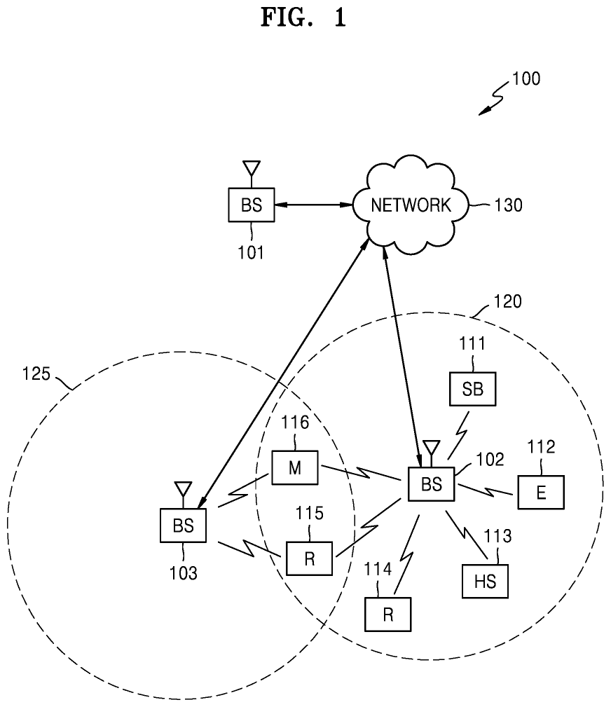

The following FIGS. 1, 2A to 2C, 3A, and 3B describe various embodiments implemented by using orthogonal frequency division multiplexing (OFDM) or orthogonal frequency division multiple access (OFDMA) communication technologies in wireless communication systems. The descriptions of FIGS. 1, 2A to 2C, 3A, and 3B do not mean physical or architectural implications for the manner in which different embodiments may be implemented. Different embodiments of the disclosure may be implemented in any suitably arranged communication systems.

FIG. 1 illustrates an example wireless network 100 according to an embodiment of the disclosure. The embodiment of the wireless network 100 shown in FIG. 1 is for illustration only. Other embodiments of the wireless network 100 can be used without departing from the scope of the disclosure.

Referring to FIG. 1, the wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station (BS)” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For example, the terms “terminal”, “user equipment” and “UE” may be used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a Wi-Fi Hotspot (HS); a UE 114, which may be located in a first residence (R); a UE 115, which may be located in a second residence (R); a UE 116, which may be a mobile device (M), such as a cellular phone, a wireless laptop computer, a wireless personal digital assistant (PDA), etc. gNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE advanced (LTE-A), WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a two-dimensional (2D) antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

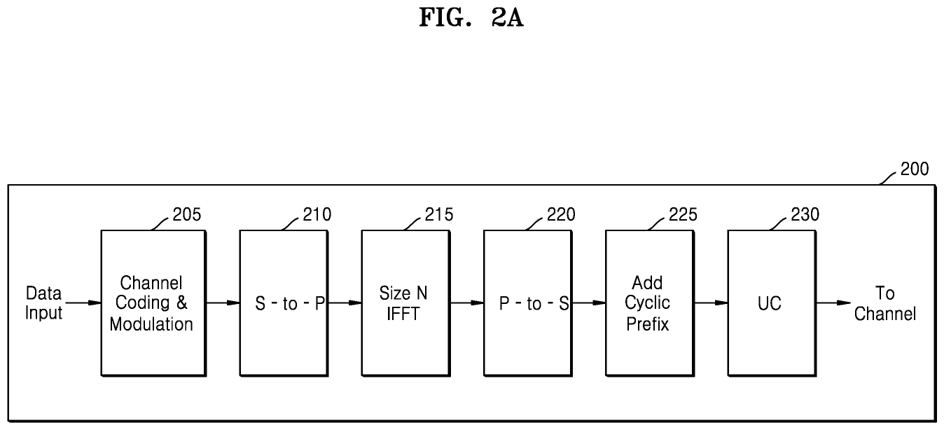

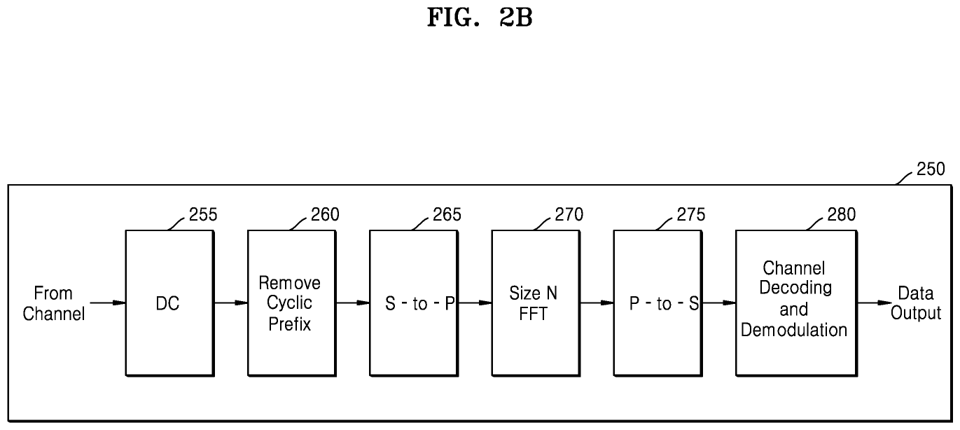

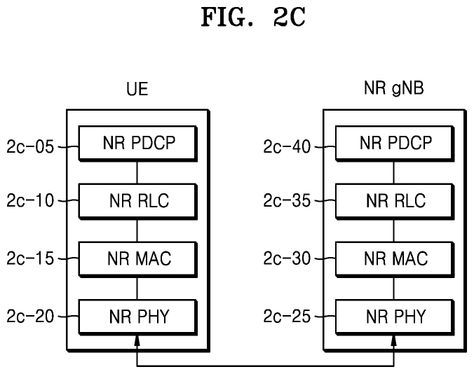

FIGS. 2A illustrates an example wireless transmission path according to an embodiment of the disclosure. And FIG. 2B illustrates an example wireless reception path according to an embodiment of the disclosure.

In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

Referring to FIGS. 2A and 2B, the transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The Parallel-to-Serial block 220 converts (such as multiplexes) parallel time domain output symbols from the Size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to a radio frequency (RF) frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The Serial-to-Parallel block 265 converts the time domain baseband signal into a parallel time domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNB s 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

FIG. 2C illustrates a radio protocol architecture of a next generation mobile communication system according to an embodiment of the disclosure.

Referring to FIG. 2C, for each of a UE and an NR base station, the radio protocols of the next generation mobile communication system include NR packet data convergence protocols (PDCPs) 2c-05 and 2c-40, NR radio link controls (RLCs) 2c-10 and 2c-35, and NR medium access controls (MACs) 2c-15 and 2c-30. The main functions of the NR PDCPs 2c-05 and 2c-40 may include a part of the following functions:
header compression and decompression: robust header compression (ROHC) only
transmission of user data
sequential delivery of upper layer protocol data units (PDU)
out-of-order delivery of upper layer PDUs
PDCP PDU reordering for reception
repeated detection of lower layer service data unit (SDU)
retransmission of PDCP SDU
encryption and decryption
timer-based SDU discard in uplink

The reordering function of an NR PDCP device refers to a function of sequentially reordering PDCP PDUs received from a lower layer based on PDCP sequence numbers (SNs), and may include a function of transmitting data to an upper layer in the reordered order, a function of transmitting data regardless of the order, a function of reordering sequences and recording lost PDCP PDUs, a function of providing a status report on the lost PDCP PDUs to a transmitting side, and a function of requesting retransmission of the lost PDCP PDUs.

The main functions of the NR RLCs 2c-10 and 2c-35 may include a part of the following functions:
transfer of upper layer PDUs
sequential delivery of upper layer PDUs
out-of-order delivery of upper layer PDUs
error correction through automatic repeat request (ARQ)
concatenation, segmentation and reassembly of RLC SDUs
re-segmentation of RLC data PDUs
reordering of RLC data PDUs
duplicate detection
protocol error detection
RLC SDU discard
RLC re-establishment

The sequential delivery function of the NR RLC device refers to a function of transmitting RLC SDUs received from the lower layer to the upper layer in a receiving sequence, and may include a function of reassembling and transmitting multiple RLC SDUs if one RLC SDU is initially segmented into the multiple RLC SDUs and received; a function of reordering the received RLC PDUs based on RLC sequence numbers (SNs) or PDCP SNs; a function of reordering sequences and recording lost RLC PDUs; a function of providing a status report on the lost RLC PDUs to the transmitting side; and a function of requesting retransmission of the lost RLC PDUs.

The out-of-order delivery function of the NR RLC device refers to a function of directly transmitting RLC SDUs received from the lower layer to the upper layer regardless of the order, and if one RLC SDU is initially segmented into multiple RLC SDUs and received, it may include: a function of reassembling the multiple RLC SDUs and transmitting them; and a function of storing the RLC SNs or PDCP SNs of the received RLC PDUs, reordering the sequence, and recording the lost RLC PDUs.

The NR MACs 2-15 and 2-30 are connected to multiple NR RLC layer devices configured in one UE, and the main functions of the NR MACs may include a part of the following functions:
mapping between logical channels and transport channels
multiplexing/de-multiplexing of MAC SDUs
scheduling information reporting
error correction through hybrid ARQ (HARQ)
priority handling between logical channels of one UE
priority handling between UEs by means of dynamic scheduling
Multimedia broadcast multicast service (MBMS) service identification
transport format selection
padding

NR physical (PHY) layers 2c-20 and 2c-25 may perform operations of channel coding and modulating upper layer data, forming the upper layer data into an OFDM symbol, transmitting the OFDM symbol through a radio channel, or of demodulating an OFDM symbol received through a radio channel, channel-decoding the OFDM symbol, and transmitting the OFDM symbol to an upper layer.

In the disclosure, a transmitting end may be a base station or UE and a receiving end may be a base station or UE. That is, the disclosure may include both a case where the transmitting end is a base station and the receiving end is a UE (downlink data transmission scenario) or a case where the transmitting end is a UE and the receiving end is a base station (uplink data transmission scenario).

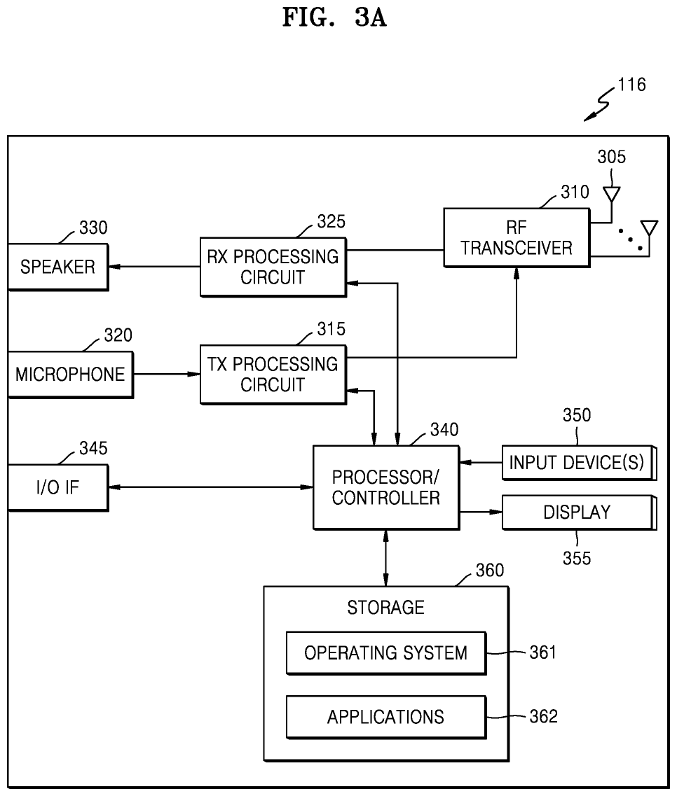

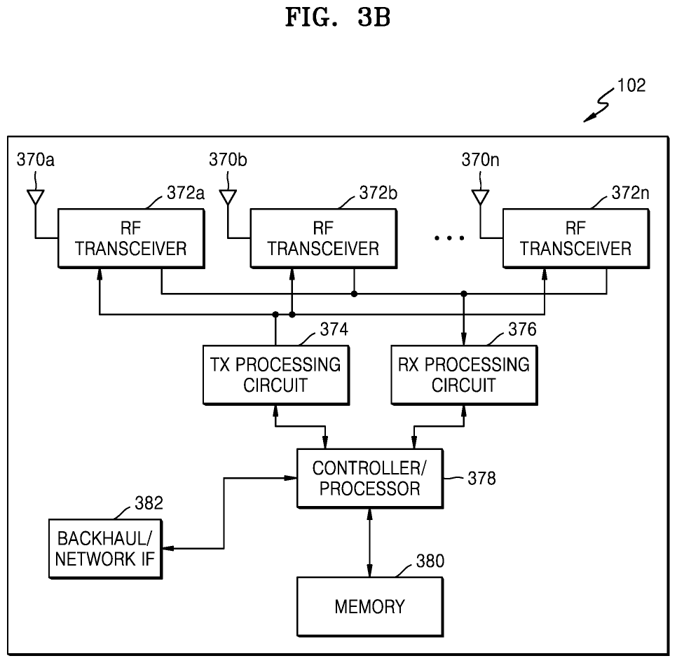

FIG. 3A illustrates an example UE 116 according to an embodiment of the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

Referring to FIG. 3A, UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to an embodiment of the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

Referring to FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web real-time communications (RTCs). The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

Those skilled in the art will understand that, “terminal” and “terminal device” as used herein include not only devices with wireless signal receiver which have no transmitting capability, but also devices with receiving and transmitting hardware which can carry out bidirectional communication on a bidirectional communication link. Such devices may include cellular or other communication devices with single-line displays or multi-line displays or cellular or other communication devices without multi-line displays; a personal communications service (PCS), which may combine voice, data processing, fax and/or data communication capabilities; a Personal Digital Assistant (PDA), which may include a radio frequency receiver, a pager, an internet/intranet access, a web browser, a notepad, a calendar and/or a Global Positioning System (GPS) receiver; a conventional laptop and/or palmtop computer or other devices having and/or including a radio frequency receiver. “Terminal” and “terminal device” as used herein may be portable, transportable, installed in vehicles (aviation, sea transportation and/or land), or suitable and/or configured to operate locally, and/or in distributed form, operate on the earth and/or any other position in space. “Terminal” and “terminal device” as used herein may also be a communication terminal, an internet terminal, a music/video playing terminal, such as a PDA, a Mobile Internet Device (MID) and/or a mobile phone with music/video playing functions, a smart television (TV), a set-top box and other devices.

With the rapid development of information industry, especially the increasing demand from mobile Internet and internet of things (IoT), it brings unprecedented challenges to the future mobile communication technology. In order to meet the unprecedented challenges, the communication industry and academia have carried out extensive research on the fifth generation (5G) mobile communication technology to face the 2020s. At present in international telecommunication union (ITU) report ITU-R M.[IMT.VISION], the framework and overall goals of the future 5G has been discussed, in which the demand outlook, application scenarios and important performance indicators of 5G are described in detail. With respect to new requirements in 5G, ITU report ITU-R M.[IMT.FUTURE TECHNOLOGY TRENDS] provides information related to the technology trends of 5G, aiming at solving significant problems such as significantly improved system throughput, consistent user experience, scalability to support IoT, delay, energy efficiency, cost, network flexibility, support of emerging services and flexible spectrum utilization. In 3rd Generation Partnership Project (3GPP), the first stage of 5G is already in progress. To support more flexible scheduling, the 3GPP decides to support variable Hybrid Automatic Repeat request-Acknowledgement (HARQ-ACK) feedback delay in 5G. In existing Long Term Evolution (LTE) systems, a time from reception of downlink data to uplink transmission of HARQ-ACK is fixed. For example, in Frequency Division Duplex (FDD) systems, the delay is 4 subframes. In Time Division Duplex (TDD) systems, a HARQ-ACK feedback delay is determined for a corresponding downlink subframe based on an uplink and downlink configuration. In 5G systems, whether FDD or TDD systems, for a determined downlink time unit (for example, a downlink slot or a downlink mini slot; for another example, a physical downlink shared channel (PDSCH) time unit), the uplink time unit (for example, a PUCCH time unit) that can feedback HARQ-ACK is variable. For example, the delay of HARQ-ACK feedback can be dynamically indicated by physical layer signaling, or different HARQ-ACK delays can be determined based on factors such as different services or user capabilities.

The 3GPP has defined three directions of 5G application scenarios-enhanced mobile broadband (eMBB), massive machine-type communication (mMTC) and ultra-reliable and low-latency communication (URLLC). The eMBB scenario aims to further improve data transmission rate on the basis of the existing mobile broadband service scenario, so as to enhance user experience and pursue ultimate communication experience between people. mMTC and URLLC are, for example, the application scenarios of the Internet of Things, but their respective emphases are different: mMTC being mainly information interaction between people and things, while URLLC mainly reflecting communication requirements between things.

A PUSCH may contain one or more (e.g., two) codeword (CW) or transport blocks (TBs). When a PUSCH may contain one or more (e.g., two) CWs (or TBs), how to schedule the PUSCH and/or how to multiplex UCI in the PUSCH is a problem to be solved.

In order to solve at least the above technical problems, embodiments of the disclosure provide a method performed by a terminal (UE), the terminal (UE), a method performed by a base station and the base station in a wireless communication system, and a non-transitory computer-readable storage medium. Hereinafter, various embodiments of the disclosure will be described in detail with reference to the accompanying drawings.

In embodiments of the disclosure, for the convenience of description, a first transceiving node and a second transceiving node are defined. For example, the first transceiving node may be a base station, and the second transceiving node may be a UE. In the following examples, the base station is taken as an example (but not limited thereto) to illustrate the first transceiving node, and the UE is taken as an example (but not limited thereto) to illustrate the second transceiving node.

Various embodiments of the disclosure are further described below with reference to the drawings.

The text and drawings are provided as examples only to help readers understand the disclosure. They are not intended and should not be interpreted as limiting the scope of the disclosure in any way. Although certain embodiments and examples have been provided, based on the content disclosed herein, it will be apparent to those skilled in the art that changes may be made to the illustrated embodiments and examples without departing from the scope of the disclosure.

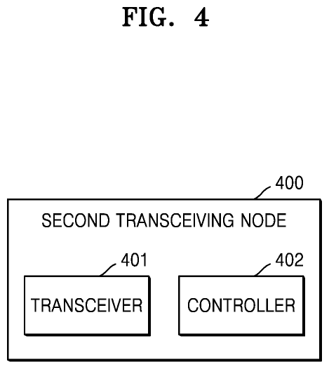

FIG. 4 illustrates a block diagram of the second transceiving node according to an embodiment of the disclosure.

Referring to FIG. 4, the second transceiving node 400 may include a transceiver 401 and a controller 402.

The transceiver 401 may be configured to receive first data and/or first control signaling from the first transceiving node, and transmit second data and/or second control signaling to the first transceiving node in a determined time unit.

The controller 402 may be an application specific integrated circuit or at least one processor. The controller 402 may be configured to control the overall operation of the second transceiving node and control the second transceiving node to implement the methods proposed in the embodiments of the disclosure. For example, the controller 402 may be configured to determine the second data and/or the second control signaling and a time unit for transmitting the second data and/or the second control signaling based on the first data and/or the first control signaling, and control the transceiver 401 to transmit the second data and/or the second control signaling to the first transceiving node in the determined time unit.

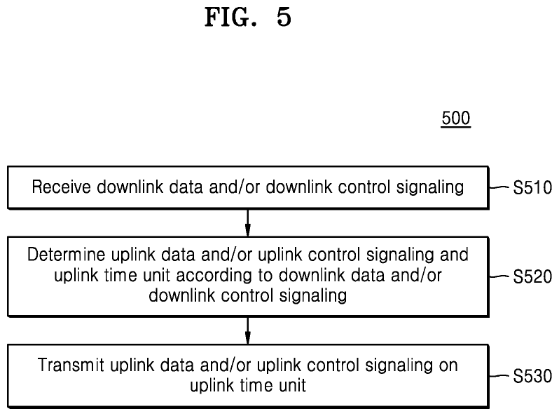

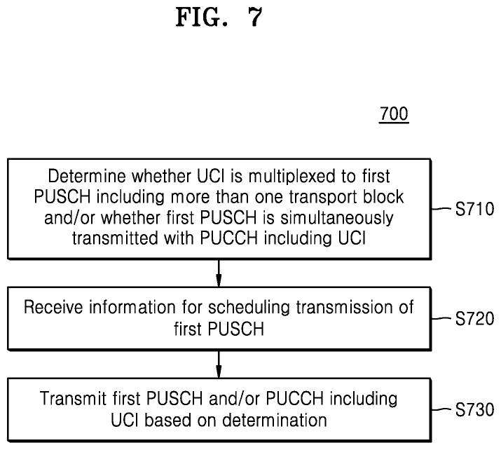

In some implementations, the controller 402 may be configured to perform one or more of operations in methods of various embodiments described below. For example, the controller 402 may be configured to perform one or more of operations in a method 500 to be described in connection with FIG. 5, and a method 700 to be described in connection with FIG. 7 later.

In some implementations, the first data may be data transmitted by the first transceiving node to the second transceiving node. In the following examples, downlink data carried by a Physical Downlink Shared Channel (PDSCH) is taken as an example (but not limited thereto) to illustrate the first data.

In some implementations, the second data may be data transmitted by the second transceiving node to the first transceiving node. In the following examples, uplink data carried by a Physical Uplink Shared Channel (PUSCH) is taken as an example to illustrate the second data, but not limited thereto.

In some implementations, the first control signaling may be control signaling transmitted by the first transceiving node to the second transceiving node. In the following examples, downlink control signaling is taken as an example (but not limited thereto) to illustrate the first control signaling. The downlink control signaling may be downlink control information (DCI) carried by a Physical Downlink Control Channel (PDCCH) and/or control signaling carried by a Physical Downlink Shared Channel (PDSCH). For example, the DCI may be UE specific DCI, and the DCI may also be common DCI. The common DCI may be DCI common to a part of UEs, such as group common DCI, and the common DCI may also be DCI common to all of the UEs. The DCI may be uplink DCI (e.g., DCI for scheduling a PUSCH) and/or downlink DCI (e.g., DCI for scheduling a PDSCH).

In some implementations, the second control signaling may be control signaling transmitted by the second transceiving node to the first transceiving node. In the following examples, uplink control signaling is taken as an example (but is not limited thereto) to illustrate the second control signaling. The uplink control signaling may be Uplink Control Information (UCI) carried by a Physical Uplink Control Channel (PUCCH) and/or control signaling carried by a Physical Uplink Shared Channel (PUSCH). A type of UCI may include one or more of: HARQ-ACK information, Scheduling Request (SR), Link Recovery Request (LRR), Chanel State Information (CSI) or Configured Grant (CG) UCI. In embodiments of the disclosure, when UCI is carried by a PUCCH, the UCI may be used interchangeably with the PUCCH.

In some implementations, a PUCCH carrying SR may be a PUCCH carrying positive SR and/or negative SR. The SR may be the positive SR and/or the negative SR.

In some implementations, the CSI may also be Part 1 CSI and/or Part 2 CSI.

In some implementations, a first time unit is a time unit in which the first transceiving node transmits the first data and/or the first control signaling. In the following examples, a downlink time unit or downlink slot is taken as an example (but not limited thereto) to illustrate the first time unit.

In some implementations, a second time unit is a time unit in which the second transceiving node transmits the second data and/or the second control signaling. In the following examples, an uplink time unit or uplink slot or PUCCH slot or Primary Cell (PCell) slot or PUCCH slot on PCell is taken as an example (but not limited thereto) to illustrate the second time unit. The “PUCCH slot” may be understood as a PUCCH transmission slot.

In some implementations, the first time unit and the second time unit may be one or more slots, one or more subslots, one or more OFDM symbols, one or more spans, or one or more subframes.

Herein, depending on the network type, the term “base station” or “BS” can refer to any component (or a set of components) configured to provide wireless access to a network, such as a Transmission Point (TP), a Transmission and Reception Point (TRP), an evolved base station (eNodeB or eNB), a 5G base station (gNB), a macrocell, a femtocell, a Wi-Fi access point (AP), or other wirelessly enabled devices. Base stations may provide wireless access in accordance with one or more wireless communication protocols, e.g., 5G 3GPP new radio (NR) interface/access, Long Term Evolution (LTE), LTE advanced (LTE-A), High Speed Packet Access (HSPA), Wi-Fi 802.11a/b/g/n/ac, etc.

In describing a wireless communication system and in the disclosure described below, higher layer signaling or higher layer signals may be signal transferring methods for transferring information from a base station to a terminal over a downlink data channel of a physical layer or from a terminal to a base station over an uplink data channel of a physical layer, and examples of the signal transferring methods may include signal transferring methods for transferring information via Radio Resource Control (RRC) signaling, Packet Data Convergence Protocol (PDCP) signaling, or a Medium Access Control (MAC) Control Element (CE).

FIG. 5 illustrates a flowchart of a method performed by a UE according to an embodiment of the disclosure.

Referring to FIG. 5, in operation S510, the UE may receive downlink data (e.g., downlink data carried by a PDSCH) and/or downlink control signaling from a base station. For example, the UE may receive the downlink data and/or the downlink control signaling from the base station based on predefined rules and/or received configuration parameters.

In operation S520, the UE determines uplink data and/or uplink control signaling and a second time unit based on the downlink data and/or downlink control signaling.

In operation S530, the UE transmits the uplink data and/or the uplink control signaling to the base station on the second time unit.

In some implementations, acknowledgement/negative acknowledgement (ACK/NACK) for downlink transmissions may be performed through HARQ-ACK.

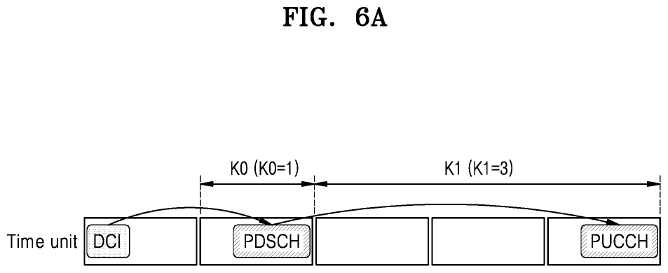

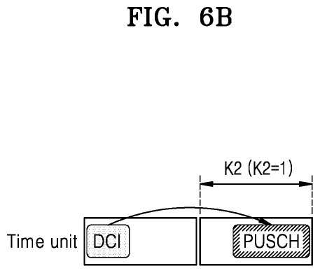

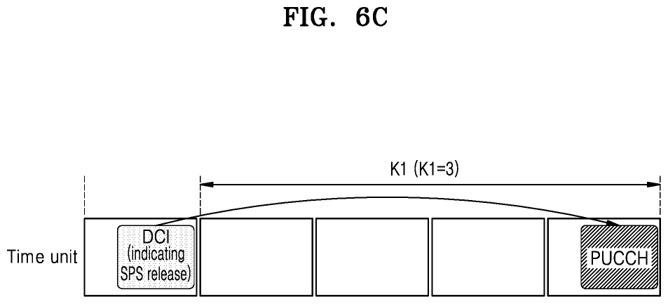

In some implementations, the downlink control signaling may include a DCI carried by a PDCCH and/or control signaling carried by a PDSCH. For example, the DCI may be used to schedule transmission of a PUSCH or reception of a PDSCH. Some examples of uplink transmission timing will be described below with reference to FIGS. 6A to 6C.

FIGS. 6A, 6B, and 6C illustrate some examples of uplink transmission timing according to various embodiments of the disclosure.

In an example, the UE receives the DCI and receives the PDSCH based on time domain resources indicated by the DCI. For example, a parameter KO may be used to represent a time interval between the PDSCH scheduled by the DCI and the PDCCH carrying the DCI, and K0 may be in units of slots. For example, FIG. 6A gives an example in which K0=1. Referring to FIG. 6A, the time interval from the PDSCH scheduled by the DCI to the PDCCH carrying the DCI is one slot. In an embodiment of the disclosure, “a UE receives a DCI” may mean that “the UE detects the DCI.”

In another example, the UE receives the DCI and transmits the PUSCH based on time domain resources indicated by the DCI. For example, a timing parameter K2 may be used to represent a time interval between the PUSCH scheduled by the DCI and the PDCCH carrying the DCI, and K2 may be in units of slots. For example, FIG. 6B gives an example in which K2=1. Referring to FIG. 6B, the time interval between the PUSCH scheduled by the DCI and the PDCCH carrying the DCI is one slot. K2 may also represent a time interval between a PDCCH for activating a configured grant (CG) PUSCH and the first activated CG PUSCH. In examples of the disclosure, unless otherwise specified, the PUSCH may be a dynamically scheduled PUSCH (e.g., scheduled by a DCI) (e.g., may be referred to as dynamic grant (DG) PUSCH, in an embodiment of the disclosure) and/or a PUSCH not scheduled by a DCI (e.g., CG PUSCH).

In yet another example, the UE receives the PDSCH, and may transmit HARQ-ACK information for the PDSCH reception in a PUCCH in the second time unit. For example, a timing parameter (which may also be referred to as a timing value) K1 (e.g., the higher layer parameter dl-DataToUL-ACID) may be used to represent a time interval between the PUCCH for transmitting the HARQ-ACK information for the PDSCH reception and the PDSCH, and K1 may be in units of second time units, such as slots or subslots. In a case where K1 is in units of slots, the time interval is a value of a slot offset between the PUCCH for feeding back the HARQ-ACK information for the PDSCH reception and the PDSCH, and K1 may be referred to as a slot timing value. For example, FIG. 6A gives an example in which K1=3. Referring to FIG. 6A, the time interval between the PUCCH for transmitting the HARQ-ACK information for the PDSCH reception and the PDSCH is 3 slots. It should be noted that in embodiments of the disclosure, the timing parameter K1 may be used interchangeably with a timing parameter K₁, the timing parameter K0 may be used interchangeably with a timing parameter K₀, and the timing parameter K2 may be used interchangeably with a timing parameter K2.

The PDSCH may be a PDSCH scheduled by the DCI and/or a semi-persistent scheduling (SPS) PDSCH. The UE will periodically receive the SPS PDSCH after the SPS PDSCH is activated by the DCI. In examples of the disclosure, the SPS PDSCH may be equivalent to a PDSCH not scheduled by the DCI/PDCCH. After the SPS PDSCH is released (deactivated), the UE will no longer receive the SPS PDSCH.

In embodiments of the disclosure, HARQ-ACK may be HARQ-ACK for a SPS PDSCH reception (e.g., HARQ-ACK not indicated by a DCI) and/or HARQ-ACK indicated by a DCI format (e.g., HARQ-ACK for a PDSCH reception scheduled by a DCI format).

In yet another example, the UE receives the DCI (e.g., DCI indicating Semi-Persistent Scheduling (SPS) PDSCH release (deactivation)), and may transmit HARQ-ACK information for the DCI in the PUCCH in the second time unit. For example, the timing parameter K1 may be used to represent a time interval between the PUCCH for transmitting the HARQ-ACK information for the DCI and the DCI, and K1 may be in units of second time units, such as slots or subslots. For example, FIG. 6C gives an example in which K1=3. Referring to FIG. 6C, the time interval between the PUCCH for transmitting the HARQ-ACK information for the DCI and the DCI is 3 slots. For example, the timing parameter K1 may be used to represent a time interval between a PDCCH reception carrying DCI indicating SPS PDSCH release (deactivation) and the PUCCH feeding back HARQ-ACK for the PDCCH reception.

In some implementations, in operation S520, the UE may report (or signal/transmit) a UE capability to the base station or indicate the UE capability. For example, the UE reports (or signals/transmits) the UE capability to the base station by transmitting the PUSCH. In this case, the UE capability information is included in the PUSCH transmitted by the UE.

In some implementations, the base station may configure higher layer signaling for the UE based on a UE capability previously received from the UE (e.g., in operation S510 in the previous downlink-uplink transmission processes). For example, the base station configures the higher layer signaling for the UE by transmitting the PDSCH. In this case, the higher layer signaling configured for the UE is included in the PDSCH transmitted by the base station. It should be noted that the higher layer signaling is higher layer signaling compared with physical layer signaling, and the higher layer signaling may include RRC signaling and/or a MAC CE.

In some implementations, downlink channels (downlink resources) may include PDCCHs and/or PDSCHs. Uplink channels (uplink resources) may include PUCCHs and/or PUSCHs.

In some implementations, the UE may be configured with two levels of priorities for uplink transmission. For example, the UE may be configured to multiplex UCIs with different priorities via higher layer signaling (e.g., through the higher layer parameter UCI-MuxWithDifferentPriority), otherwise (e.g., if the UE is not configured to multiplex UCIs with different priorities), the UE performs prioritization for PUCCHs and/or PUSCHs with different priorities. For example, the two levels of priorities may include a first priority and a second priority which are different from each other. In an example, the first priority may be higher than the second priority, that is, the first priority is the higher priority, and the second priority is the lower priority. In another example, the first priority may be lower than the second priority. However, embodiments of the disclosure are not limited to this, and for example, the UE may be configured with more than two levels of priorities. For the sake of convenience, in embodiments of the disclosure, description will be made considering that the first priority is higher than the second priority. It should be noted that all embodiments of the disclosure are applicable to situations where the first priority may be higher than the second priority; all embodiments of the disclosure are applicable to situations where the first priority may be lower than the second priority; and all embodiments of the disclosure are applicable to situations where the first priority may be equal to the second priority.

For example, multiplexing of multiple PUCCHs and/or PUSCHs overlapping in time domain may include multiplexing UCI information of the PUCCH in a PUCCH or PUSCH.

For example, prioritizing of two PUCCHs and/or PUSCHs overlapping in time domain by the UE may include that the UE transmits the PUCCH or the PUSCH with the higher priority and/or the UE does not transmit the PUCCH or the PUSCH with the lower priority.

In some implementations, the UE may be configured with a subslot-based PUCCH transmission. For example, a subslot length parameter (which may also be referred to as a parameter with respect to a subslot length in embodiments of the disclosure) (e.g., the higher layer parameter subslotLengthForPUCCH) of each PUCCH configuration parameter of the first PUCCH configuration parameter and the second PUCCH configuration parameter may be 7 OFDM symbols or 6 OFDM symbols or 2 OFDM symbols. Subslot configuration length parameters in different PUCCH configuration parameters may be configured separately. If no subslot length parameter is configured in a PUCCH configuration parameter, the scheduling time unit of the PUCCH configuration parameter is one slot by default. If a subslot length parameter is configured in the PUCCH configuration parameter, the scheduling time unit of the PUCCH configuration parameter is L (L is the configured subslot configuration length) OFDM symbols.

The mechanism of slot-based PUCCH transmissions is basically the same as that of subslot-based PUCCH transmissions. In the disclosure, a slot may be used to represent a PUCCH occasion unit; for example, if the UE is configured with subslots, a slot which is a PUCCH occasion unit may be replaced with a subslot. For example, it may be specified by protocols that if the UE is configured with the subslot length parameter (e.g., the higher layer parameter subslotLengthForPUCCH), unless otherwise indicated, a number of symbols contained in the slot of the PUCCH transmission is indicated by the subslot length parameter.

For example, if the UE is configured with the subslot length parameter, and subslot n is the last uplink subslot overlapping with a PDSCH reception or PDCCH reception (e.g., SPS PDSCH release, and/or indicating SCell dormancy, and/or triggering a Type-3 HARQ-ACK codebook report and without scheduling a PDSCH reception), then HARQ-ACK information for the PDSCH reception or PDCCH reception is transmitted in an uplink subslot n+k, where k is determined by the timing parameter K1 (the definition of the timing parameter K1 may refer to the previous description). For another example, if the UE is not configured with the subslot length parameter, and slot n is the last uplink slot overlapping with a downlink slot where the PDSCH reception or PDCCH reception is located, then the HARQ-ACK information for the PDSCH reception or PDCCH reception is transmitted in an uplink slot n+k, where K is determined by the timing parameter K1.

In embodiments of the disclosure, unicast may refer to a manner in which a network communicates with a UE, and multicast (or groupcast) may refer to a manner in which a network communicates with multiple UEs. For example, a unicast PDSCH may be a PDSCH received by one UE, and the scrambling of the PDSCH may be based on a Radio Network Temporary Identifier (RNTI) specific to the UE, e.g., Cell-RNTI (C-RNTI). A multicast PDSCH may be a PDSCH received by more than one UE simultaneously, and the scrambling of the multicast PDSCH may be based on a UE-group common RNTI. For example, the UE-group common RNTI for scrambling the multicast PDSCH may include an RNTI (which may be referred to as Group RNTI (G-RNTI) in embodiments of the disclosure) for scrambling of a dynamically scheduled multicast transmission (e.g., PDSCH) or an RNTI (which may be referred to as group configured scheduling RNTI (G-CS-RNTI) in embodiments of the disclosure) for scrambling of a multicast SPS transmission (e.g., SPS PDSCH). UCI(s) of the unicast PDSCH may include HARQ-ACK information, SR, or CSI of the unicast PDSCH reception. UCI(s) of the multicast PDSCH may include HARQ-ACK information for the multicast PDSCH reception. In embodiments of the disclosure, “multicast” may also be replaced by “broadcast”.

In some implementations, a HARQ-ACK codebook may include HARQ-ACK information for one or more PDSCHs and/or DCI. If the HARQ-ACK information for the one or more PDSCHs and/or DCI is transmitted in a same second time unit, the UE may generate the HARQ-ACK codebook based on a predefined rule. For example, if a PDSCH is successfully decoded, the HARQ-ACK information for the PDSCH reception is positive ACK. The positive ACK may be represented by 1 in the HARQ-ACK codebook, for example. If a PDSCH is not successfully decoded, the HARQ-ACK information for the PDSCH reception is Negative ACK (NACK). NACK may be represented by 0 in the HARQ-ACK codebook, for example. For example, the UE may generate the HARQ-ACK codebook based on the pseudo code specified by protocols. In an example, if the UE receives a DCI format that indicates SPS PDSCH release (deactivation), the UE transmits HARQ-ACK information (ACK) for the DCI format. In another example, if the UE receives a DCI format that indicates secondary cell dormancy, the UE transmits the HARQ-ACK information (ACK) for the DCI format. In yet another example, if the UE receives a DCI format that indicates to transmit HARQ-ACK information (e.g., a Type-3 HARQ-ACK codebook) of all HARQ-ACK processes of all configured serving cells, the UE transmits the HARQ-ACK information of all HARQ-ACK processes of all configured serving cells. In order to reduce a size of the Type-3 HARQ-ACK codebook, in an enhanced Type-3 HARQ-ACK codebook, the UE may transmit HARQ-ACK information of a specific HARQ-ACK process of a specific serving cell based on an indication of the DCI. In yet another example, if the UE receives a DCI format that schedules a PDSCH, the UE transmits HARQ-ACK information for the PDSCH reception. In yet another example, the UE receives a SPS PDSCH, and the UE transmits HARQ-ACK information for the SPS PDSCH reception. In yet another example, if the UE is configured by higher layer signaling to receive a SPS PDSCH, the UE transmits HARQ-ACK information for the SPS PDSCH reception. The reception of the SPS PDSCH configured by higher layer signaling may be cancelled by other signaling. In yet another example, if at least one uplink symbol (e.g., OFDM symbol) of the UE in a semi-static frame structure configured by higher layer signaling overlaps with a symbol of the SPS PDSCH reception, the UE does not receive the SPS PDSCH. In yet another example, if the UE is configured by higher layer signaling to receive a SPS PDSCH according to a predefined rule, the UE transmits HARQ-ACK information for the SPS PDSCH reception. It should be noted that, in embodiments of the disclosure, “‘A’ overlaps with ‘B’” may mean that ‘A’ at least partially overlaps with ‘B’. That is, “‘A’ overlaps with ‘B’” includes a case where ‘A’ completely overlaps with ‘B’. “'A′ overlaps with ‘B’” may mean that ‘A’ overlaps with ‘B’ in time domain and/or ‘A’ overlaps with ‘B’ in frequency domain.

In some implementations, if HARQ-ACK information transmitted in a same second time unit does not include HARQ-ACK information for any DCI format, nor does it include HARQ-ACK information for a dynamically scheduled PDSCH (e.g., a PDSCH scheduled by a DCI format) and/or DCI, or the HARQ-ACK information transmitted in the same second time unit only includes HARQ-ACK information for one or more SPS PDSCH receptions, the UE may generate HARQ-ACK information (e.g., HARQ-ACK information only for SPS PDSCH receptions) according to a rule for generating a HARQ-ACK codebook for SPS PDSCHs. The UE may multiplex the HARQ-ACK information only for SPS PDSCH receptions in a specific PUCCH resource. For example, if the UE is configured with a PUCCH list parameter for SPS (e.g., SPS-PUCCH-AN-List), the UE multiplexes the HARQ-ACK information only for SPS PDSCH receptions in a PUCCH of a PUCCH list for SPS. For example, the UE determines a PUCCH resource in the PUCCH list for the SPS according to a number of HARQ-ACK information bits. If the UE is not configured with the PUCCH list parameter for SPS, the UE multiplexes the HARQ-ACK information only for SPS PDSCH receptions in a PUCCH resource specific to SPS HARQ-ACK (for example, the PUCCH resource is configured by the parameter n1PUCCH-AN).

In some implementations, if the HARQ-ACK information transmitted in the same second time unit includes HARQ-ACK information for a DCI format, and/or a dynamically scheduled PDSCH (e.g., a PDSCH scheduled by a DCI format), the UE may generate HARQ-ACK information according to a rule for generating a HARQ-ACK codebook for a dynamically scheduled PDSCH and/or a DCI format. For example, the UE may determine to generate a semi-static HARQ-ACK codebook (e.g., Type-1 HARQ-ACK codebook) or a dynamic HARQ-ACK codebook (e.g., Type-2 HARQ-ACK codebook in 3GPP) according to a PDSCH HARQ-ACK codebook configuration parameter (e.g., the higher layer parameter pdsch-HARQ-ACK-Codebook). The dynamic HARQ-ACK codebook may also be an enhanced dynamic HARQ-ACK codebook (e.g., Type-2 HARQ-ACK codebook based on grouping and HARQ-ACK retransmission). The UE may multiplex the HARQ-ACK information in a PUCCH resource for HARQ-ACK associated with dynamically scheduling, which may be configured in a resource set list parameter (e.g., the parameter resourceSetToAddModList). The UE determines a PUCCH resource set (e.g., the parameter PUCCH-ResourceSet) in a resource set list according to a number of HARQ-ACK information bits, and the PUCCH resource may be determined as a PUCCH in the PUCCH resource set according to a PRI (PUCCH Resource Indicator) field indication in the last DCI format.

In some implementations, if the HARQ-ACK information transmitted in the same second time unit includes only HARQ-ACK information for SPS PDSCHs (e.g., a PDSCH not scheduled by a DCI format), the UE may generate the HARQ-ACK codebook according to a rule for generating a HARQ-ACK codebook for SPS PDSCH receptions (e.g., the pseudo code of a HARQ-ACK codebook for SPS PDSCH receptions).

The semi-static HARQ-ACK codebook (e.g., Type-1 HARQ-ACK codebook), may determine the size of the HARQ-ACK codebook and an order of HARQ-ACK bits according to a semi-statically configured parameter (e.g., a parameter configured by higher layer signaling). For a serving cell c, an active downlink bandwidth part (BWP) and an active uplink BWP, the UE determines a set of M_{A,c} occasions for candidate PDSCH receptions for which the UE can transmit corresponding HARQ-ACK information in a PUCCH in an uplink slot n_{U}.

M_{A,c} may be determined by at least one of:
a) HARQ-ACK slot timing values K1 of the active uplink BWP;
b) a downlink time domain resource allocation (TDRA) table;
c) an uplink subcarrier spacing (SCS) configuration and a downlink SCS configuration;
d) a semi-static uplink and downlink frame structure configuration;
e) a downlink slot offset parameter (e.g., the higher layer parameter N_{slot,offset,c}^{DL}) for the serving cell c and its corresponding slot offset SCS (e.g., the higher layer parameter μ_{offset,DL,c}), and a slot offset parameter (e.g., the higher layer parameter N_{slot,offset}^{UL}) for a primary serving cell and its corresponding slot offset SCS (e.g., the higher layer parameter μ_{offset,UL})

The parameter K1 is used to determine a candidate uplink slot, and then determine candidate downlink slots according to the candidate uplink slot. The candidate downlink slots satisfy at least one of the following conditions: (i) if the time unit of the PUCCH is a subslot, the end of at least one candidate PDSCH reception in the candidate downlink slots overlaps with the candidate uplink slot in time domain; or (ii) if the time unit of the PUCCH is a slot, the end of the candidate downlink slots overlap with the candidate uplink slot in time domain. It should be noted that, in embodiments of the disclosure, a starting symbol may be used interchangeably with a starting position, and an end symbol may be used interchangeably with an end position. In some implementations, the starting symbol may be replaced by the end symbol, and/or the end symbol may be replaced by the starting symbol.

A number of PDSCHs in a candidate downlink slot for which HARQ-ACK needs to be fed back is determined by a maximum value of a number of non-overlapping valid PDSCHs in the downlink slot (e.g., the valid PDSCHs may be PDSCHs that do not overlap with semi-statically configured uplink symbols). Time domain resources occupied by the PDSCHs may be determined by (i) a time domain resource allocation table configured by higher layer signaling (in embodiments of the disclosure, it may also be referred to as a table associated with time domain resource allocation) and (ii) a certain row in the time domain resource allocation table dynamically indicated by a DCI. Each row in the time domain resource allocation table may define information with respect to time domain resource allocation. For example, for the time domain resource allocation table, an indexed row defines a timing value (e.g., time unit (e.g., slot) offset (e.g., K0)) between a PDCCH and a PDSCH, and a start and length indicator (SLIV), or directly defines a starting symbol and allocation length. For example, for the first row of the time domain resource allocation table, a start OFDM symbol is 0 and an OFDM symbol length is 4; for the second row of the time domain resource allocation table, the start OFDM symbol is 4 and the OFDM symbol length is 4; and for the third row of the time domain resource allocation table, the start OFDM symbol is 7 and the OFDM symbol length is 4. The DCI for scheduling the PDSCH may indicate any row in the time domain resource allocation table. When all OFDM symbols in the downlink slot are downlink symbols, the maximum value of the number of non-overlapping valid PDSCHs in the downlink slot is 2. At this time, the Type-1 HARQ-ACK codebook may need to feed back HARQ-ACK information for two PDSCHs in the downlink slot on the serving cell.

In some implementations, the dynamic HARQ-ACK codebook (e.g., Type-2 HARQ-ACK codebook) and/or the enhanced dynamic HARQ-ACK codebook (e.g., Type-2 HARQ-ACK based on grouping and HARQ-ACK retransmission) may determine a size and an order of the HARQ-ACK codebook according to an assignment indicator. For example, the assignment indicator may be a Downlink Assignment Indicator (DAI). In the following embodiments, the assignment indicator as the DAI is taken as an example for illustration. However, the embodiments of the disclosure are not limited thereto, and any other suitable assignment indicator may be adopted.

In some implementations, a DAI field includes at least one of a first DAI and a second DAI.

In some examples, the first DAI may be a Counter-DAI (C-DAI). The first DAI may indicate an accumulative number of at least one of DCI scheduling PDSCH(s), DCI indicating SPS PDSCH release (deactivation), or DCI indicating secondary cell dormancy. For example, the accumulative number may be an accumulative number up to the current serving cell and/or the current time unit. For example, C-DAI may refer to: an accumulative number of {serving cell, time unit} pair(s) scheduled by PDCCH(s) up to the current time unit within a time window (which may also include a number of PDCCHs (e.g., PDCCHs indicating SPS release and/or PDCCHs indicating secondary cell dormancy)); or an accumulative number of PDCCH(s) up to the current time unit; or an accumulative number of PDSCH transmission(s) up to the current time unit; or an accumulative number of {serving cell, time unit} pair(s) in which PDSCH transmission(s) related to PDCCH(s) (e.g., scheduled by the PDCCH(s)) and/or PDCCH(s) (e.g., PDCCH indicating SPS release and/or PDCCH indicating secondary cell dormancy) is present, up to the current serving cell and/or the current time unit; or an accumulative number of PDSCH(s) with corresponding PDCCH(s) and/or PDCCHs (e.g., PDCCHs indicating SPS release and/or PDCCHs indicating secondary cell dormancy) already scheduled by a base station up to the current serving cell and/or the current time unit; or an accumulative number of PDSCHs (the PDSCHs are PDSCHs with corresponding PDCCHs) already scheduled by the base station up to the current serving cell and/or the current time unit; or an accumulative number of time units with PDSCH transmissions (the PDSCHs are PDSCHs with corresponding PDCCHs) already scheduled by the base station up to the current serving cell and/or the current time unit. The order of each bit in the HARQ-ACK codebook corresponding to at least one of PDSCH reception(s), DCI(s) indicating SPS PDSCH release (deactivation), or DCI(s) indicating secondary cell dormancy may be determined by the time when the first DAI is received and the information of the first DAI. The first DAI may be included in a downlink DCI format.

In some examples, the second DAI may be a Total-DAI (T-DAI). The second DAI may indicate a total number of at least one of all PDSCH receptions, DCI indicating SPS PDSCH release (deactivation), or DCI indicating secondary cell dormancy. For example, the total number may be a total number of all serving cells up to the current time unit. For example, T-DAI may refer to: a total number of {serving cell, time unit} pairs scheduled by PDCCH(s) up to the current time unit within a time window (which may also include a number of PDCCHs for indicating SPS release); or a total number of PDSCH transmissions up to the current time unit; or a total number of {serving cell, time unit} pairs in which PDSCH transmission(s) related to PDCCH(s) (e.g., scheduled by the PDCCH) and/or PDCCH(s) (e.g., a PDCCH indicating SPS release and/or a PDCCH indicating secondary cell dormancy) is present, up to the current serving cell and/or the current time unit; or a total number of PDSCHs with corresponding PDCCHs and/or PDCCHs (e.g., PDCCHs indicating SPS release and/or PDCCHs indicating secondary cell dormancy) already scheduled by a base station up to the current serving cell and/or the current time unit; or a total number of PDSCHs (the PDSCHs are PDSCHs with corresponding PDCCHs) already scheduled by the base station up to the current serving cell and/or the current time unit; or a total number of time units with PDSCH transmissions (e.g., the PDSCHs are PDSCHs with corresponding PDCCHs) already scheduled by the base station up to the current serving cell and/or the current time unit. The second DAI may be included in the downlink DCI format and/or an uplink DCI format. The second DAI included in the uplink DCI format is also referred to as UL DAI.

In the following examples, the first DAI as the C-DAI and the second DAI as the T-DAI are taken as an example for illustration, but the examples are not limited thereto.

Tables 1 and 2 show a correspondence between the DAI field and V_{T-DAI,m} or V_{C-DAI,c,m} or V_{T-DAI}^{UL}. Numbers of bits of the C-DAI and T-DAI are limited.

For example, in case that the C-DAI or T-DAI is represented with 2 bits, the value of the C-DAI or T-DAI in the DCI may be determined by equations in Table 1. V_{T-DAI,m} or V_{T-DAI}^{UL} is the value of the T-DAI in the DCI received in a PDCCH Monitoring Occasion (MO) in, and V_{C-DAI,c,m} is the value of the C-DAI in the DCI for a serving cell c received in the PDCCH monitoring occasion in. Both V_{T-DAI,m} and V_{C-DAI,c,m} are related to a number of bits of the DAI field in the DCI. MSB is the Most Significant Bit and LSB is the Least Significant Bit.

TABLE 1

| MSB, LSB of DAI | V_{T-DAI,m} or V_{C-DAI,c,m} or | |
|---|---|---|
| Field | V_{T-DAI}^{UL} | Y |
| 0,0 | 1 | (Y − 1) mod 4 + 1 = 1 |
| 0,1 | 2 | (Y − 1) mod 4 + 1 = 2 |
| 1,0 | 3 | (Y − 1) mod 4 + 1 = 3 |
| 1,1 | 4 | (Y − 1) mod 4 + 1 = 4 |

For example, when the C-DAI or T-DAI is 1, 5 or 9, as shown in Table 1, all of the DAI field are indicated with “00”, and the value of V_{T-DAI,m} or V_{C-DAI,c,m} is represented as “1” by the equation in Table 1. Y may represent the value of the DAI corresponding to the number of DCIs actually transmitted by the base station (the value of the DAI before conversion by the equation in the table).

For example, in case that the C-DAI or T-DAI in the DCI is 1 bit, values greater than 2 may be represented by equations in Table 2.

TABLE 2

| DAI field | V_{T-DAI,m} or V_{C-DAI,c,m} | Y |
|---|---|---|
| 0 | 1 | (Y − 1) mod 2 + 1 = 1 |
| 1 | 2 | (Y − 1) mod 2 + 1 = 2 |

In some implementations, whether to feed back HARQ-ACK information may be configured by higher layer parameters or dynamically indicated by a DCI. The mode of feeding back (or reporting) the HARQ-ACK information (HARQ-ACK feedback mode or HARQ-ACK reporting mode) may also be at least one of the following modes.

HARQ-ACK feedback mode 1: transmitting ACK or NACK (ACK/NACK). For example, for a PDSCH reception, if the UE decodes a corresponding transport block correctly, the UE transmits ACK; and/or, if the UE does not decode the corresponding transport block correctly, the UE transmits NACK. For example, a HARQ-ACK information bit of the HARQ-ACK information provided according to the HARQ-ACK feedback mode 1 is an ACK value or a NACK value.

HARQ-ACK feedback mode 2: transmitting NACK only (NACK-only). For example, for a PDSCH reception, if the UE decodes the corresponding transport block correctly, the UE does not transmit the HARQ-ACK information; and/or, if the UE does not decode the corresponding transport block correctly, the UE transmits NACK. For example, at least one HARQ-ACK information bit of the HARQ-ACK information provided according to the HARQ-ACK feedback mode 2 is a NACK value. For example, for the HARQ-ACK feedback mode 2, the UE does not transmit a PUCCH that would include only HARQ-ACK information with ACK values.

It should be noted that, unless the context clearly indicates otherwise, all or one or more of the methods, steps or operations described in embodiments of the disclosure may be specified by protocols and/or configured by higher layer signaling and/or indicated by dynamic signaling. The dynamic signaling may be PDCCH and/or DCI and/or DCI format. For example, SPS PDSCH and/or CG PUSCH may be dynamically indicated in a corresponding activated DCI/DCI format /PDCCH. All or one or more of the described methods, steps and operations may be optional. For example, if a certain parameter (e.g., parameter X) is configured, the UE performs a certain approach (e.g., approach A), otherwise (if the parameter, e.g., parameter X, is not configured), the UE performs another approach (e.g., approach B). Unless otherwise specified, the parameters in the embodiments of the disclosure may be higher layer parameters. For example, the higher layer parameters may be parameters configured or indicated by higher layer signaling (e.g., RRC signaling).

It should be noted that, a Primary Cell (PCell) or Primary Secondary Cell (PSCell) in embodiments of the disclosure may be used interchangeably with a cell having a PUCCH.

It should be noted that, methods for downlink in embodiments of the disclosure may also be applicable to uplink, and methods for uplink may also be applicable to downlink. For example, a PDSCH may be replaced with a PUSCH, a SPS PDSCH may be replaced with a CG PUSCH, and downlink symbols may be replaced with uplink symbols, so that methods for downlink may be applicable to uplink.

It should be noted that, methods applicable to scheduling multiple PDSCH/PUSCHs in embodiments of the disclosure may also be applicable to a PDSCH/PUSCH transmission with repetitions. For example, a PDSCH/PUSCH of multiple PDSCHs/PUSCHs may be replaced by a repetition of multiple repetitions of the PDSCH/PUSCH transmission.

It should be noted that in methods of the disclosure, “configured and/or indicated with a transmission with repetitions” may be understood that the number of the repetitions of the transmission is greater than 1. For example, “configured and/or indicated with a transmission with repetitions” may be replaced with “PUCCH repeatedly transmitted on more than one slot/sub-slot”. “Not configured and/or indicated with a transmission with repetitions” may be understood that the number of the repetitions of the transmission equals to 1. For example, “PUCCH that is not configured and/or indicated with repetitions” may be replaced by “PUCCH transmission with the number of the repetitions of 1”. For example, the UE may be configured with a parameter N_{PUCCH}^{repeat} related to the number of repetitions of PUCCH; When the N_{PUCCH}^{repeat} is greater than 1, it may mean that the UE is configured with a PUCCH transmission with repetitions, and the UE may repeat the PUCCH transmission on N_{PUCCH}^{repeat} time units (e.g., slots); when the parameter is equal to 1, it may mean that the UE is not configured with a PUCCH transmission with repetitions. For example, the repeatedly transmitted PUCCH may include only one type of UCI. If the PUCCH is configured with repetitions, in embodiments of the disclosure, a repetition of the multiple repetitions of the PUCCH may be used as a PUCCH (or a PUCCH resource), or all of the repetitions of the PUCCH may be used as a PUCCH (or a PUCCH resource), or a specific repetition of the multiple repetitions of the PUCCH may be used as a PUCCH (or a PUCCH resource).

It should be noted that, in methods of the disclosure, a PDCCH and/or DCI and/or a DCI format schedules multiple PDSCHs/PUSCHs, which may be multiple PDSCHs/PUSCHs on a same serving cell and/or multiple PDSCHs/PUSCHs on different serving cells.

It should be noted that, the multiple manners described in the disclosure may be combined in any order. In a combination, a manner may be performed one or more times.

It should be noted that, steps of methods of the disclosure may be implemented in any order.

It should be noted that, in embodiments of the disclosure, “canceling a transmission” may mean canceling the transmission of the entire uplink channel and/or cancelling the transmission of a part of the uplink channel.

It should be noted that, in embodiments of the disclosure, “an order from small to large” (e.g., an ascending order) may be replaced by “an order from large to small” (e.g., a descending order), and/or “an order from large to small” (e.g., a descending order) may be replaced by “an order from small to large” (e.g., an ascending order).

It should be noted that, in embodiments of the disclosure, a PUCCH/PUSCH carrying/with A may be understood as a PUCCH/PUSCH only carrying/with A, and may also be understood as a PUCCH/PUSCH carrying/with at least A.

It should be noted that, in embodiments of the disclosure, “slot” may be replaced by “subslot” or “time unit”.

It should be noted that, in embodiments of the disclosure, “performing a predefined methods (or step) if a predefined condition is satisfied” and “not performing the predefined methods (or step) if the predefined conditions is not satisfied” may be used interchangeably. “Not performing a predefined method (or step) if a predefined condition is satisfied” and “performing the predefined methods (or step) if the predefined condition is not satisfied” may be used interchangeably. In embodiments of the disclosure, the term “predefined condition” may be used interchangeably with “specified condition”, “predetermined condition” or “condition”.

It should be noted that, in embodiments of the disclosure, the parameters, information or configurations may be preconfigured or predefined or configured by a base station. Therefore, in some cases, the parameters, information or configurations may be referred to as predefined parameters, predefined information or predefined configurations, respectively. In embodiments of the disclosure, the meaning of preconfiguring certain information or parameters in the UE may be interpreted as default information or parameters embedded in the UE when manufacturing the UE, or information or parameters pre-acquired by higher layer signaling (e.g., RRC) configurations and stored in the UE, or information or parameters acquired from the base station and stored.

It should be noted that, in embodiments of the disclosure, “CW” and “TB” may be used interchangeably.

### Manner MN1

According to embodiments of manner MN1, a UE may be configured or provided with a configuration for indicating a maximum number of CWs (or TBs) included in a PUSCH. For example, the UE may receive the configuration from a base station. The PUSCH may be a PUSCH dynamically scheduled by a DCI or a CG PUSCH.

In some implementations, the UE may receive a first parameter. The first parameter may be a higher layer parameter. The first parameter may be used to indicate a maximum number N1 of CWs (or TBs) in one PUSCH (e.g., PUSCH scheduled by a DCI format), where N1 may be a positive integer. For example, N1 may be 1 or 2. If the UE is configured with the first parameter, when the UE receives a DCI format scheduling the PUSCH, a maximum number (or a number) of CWs (or TBs) included in the PUSCH is N1. In this manner, a number of CWs (or TBs) included in the PUSCH transmitted by the UE may not exceed the maximum number indicated by the first parameter.

In some implementations, the UE may receive a second parameter. The second parameter may be a higher layer parameter. The second parameter may be used to indicate that the maximum number of CWs (or TBs) in one PUSCH (e.g., the PUSCH scheduled by the DCI format) is a first predefined number, for example, the first predefined number may be 2. If the UE is configured with the second parameter, when the UE receives a DCI format scheduling the PUSCH, it may be determined that the maximum number (or the number) of CWs (or TBs) included in the PUSCH is the first predefined number. If the UE is not configured with the second parameter, when the UE receives a DCI format scheduling the PUSCH, it may be determined that the maximum number (or the number) of CWs (or TBs) included in the PUSCH is a default number. For example, the default number may be 1.

In some implementations, the UE may receive a third parameter. The third parameter may be a higher layer parameter. The third parameter may be used to indicate a maximum number N2 of CWs (or TBs) in one PUSCH (e.g., CG PUSCH), where N2 may be a positive integer. For example, N2 may be 1 or 2. If the UE is configured with the third parameter, when a PUSCH (e.g., CG PUSCH) is transmitted, the maximum number (or the number) of CWs (or TBs) included in the PUSCH is N2.

In some implementations, the UE may receive a fourth parameter. The fourth parameter may be a higher layer parameter. The fourth parameter may be used to indicate that the maximum number of CWs (or TBs) in one PUSCH (e.g., CG PUSCH) is a second predefined number, and for example, the second predefined number may be 2. If the UE is configured with the fourth parameter, when the UE transmits a PUSCH (e.g., CG PUSCH), the maximum number (or the number) of CWs (or TBs) included in the PUSCH is the second predefined number. If the UE is not configured with the fourth parameter, when the UE transmits a PUSCH, the maximum number (or the number) of CWs (or TBs) included in the PUSCH (e.g., CG PUSCH) is a default number. For example, the default number may be 1.

Each of the first parameter, the second parameter, the third parameter or the fourth parameter may be configured separately for each serving cell, or separately for each PUCCH group, or separately for each BWP, or in a PUSCH configuration parameter (e.g., PUSCH-Config). The method can improve the flexibility of the configuration.

Each of the third parameter or the fourth parameter may be configured for each CG PUSCH configuration, for example, in a CG PUSCH configuration parameter (e.g., ConfiguredGrantConfig). The method can improve the flexibility of the configuration.

The UE may report or indicate a capability to support the maximum number (or the number) of CWs (or TBs) in the PUSCH. The capability may be reported for a PUSCH scheduled by a DCI and a CG PUSCH separately. For example, the base station may perform uplink (e.g., PUSCH) scheduling based on the capability reported or indicated by the UE. The method can enable the base station to perform the uplink scheduling according to the capability of the UE, and avoid the base station from scheduling transmission modes that are not supported by the UE, thereby improving the reliability of uplink transmission.

If the maximum number (or the number) of CWs (or TBs) in one PUSCH is N, where N is an integer greater than 1 (for example, N is equal to 2), how to multiplex UCI information to the PUSCH is a problem to be solved. In order to at least solve this problem, at least one of manners MN2 to MN4 may be used. It should be noted that, in embodiments of the disclosure, “N” used when describing the number of CWs or TBs may be replaced by “more than one”. For example, “N CWs” may be replaced by “more than one CW”. For another example, “N TBs” may be replaced by “more than one TB”.

### Manner MN2

According to some embodiments of manner MN2, the UE may be configured or provided with a configuration indicating whether the UE can multiplex UCI in a PUSCH including N CWs, and/or whether the UE can simultaneously transmit a PUSCH including N CWs with a PUCCH. For example, the configuration may be used to indicate that UE can multiplex UCI in a PUSCH including N CWs, and/or UE can simultaneously transmit a PUSCH including N CWs with a PUCCH. For example, the UE may receive the configuration from the base station. As an example, when the UE is not configured or provided with the configuration, it may be considered that the UE cannot multiplex UCI in a PUSCH including N CWs, and/or the UE cannot simultaneously transmit a PUSCH including N CWs with a PUCCH.

In some implementations, it may be indicated by a fifth parameter that the UE can multiplex UCI in a PUSCH including N CWs. As an example, if the UE is configured with the fifth parameter, when a PUCCH overlaps with a PUSCH including N CWs in time domain, the UE can multiplex the UCI (e.g., HARQ-ACK and/or CSI) included in the PUCCH in the PUSCH. If the UE is not configured with the fifth parameter, when a PUCCH overlaps with a PUSCH including N CWs in time domain, the UE transmits the PUCCH, and/or the UE does not transmit the PUSCH. Or, if the UE is not configured with the fifth parameter, when a PUCCH overlaps with a PUSCH including N CWs in time domain, the UE simultaneously transmits the PUCCH and the PUSCH. For another example, if the UE is not configured with the fifth parameter, when a PUCCH overlaps with a PUSCH including N CWs in a same serving cell in time domain, the UE transmits the PUCCH, and/or the UE does not transmit the PUSCH. For still another example, if the UE is not configured with the fifth parameter, when a PUCCH overlaps with a PUSCH including N CWs in a different serving cell in time domain, the UE simultaneously transmits the PUCCH and the PUSCH. For yet another example, if the UE is not configured with the fifth parameter, when the PUCCH does not overlap with any PUSCH including only one CW in time domain, the PUCCH is transmitted and the PUSCH including N CWs is not transmitted. For yet another example, if the UE is not configured with the fifth parameter, when the PUCCH overlaps with a PUSCH including N CWs and a second PUSCH including only one CW (e.g., PUSCH scheduled by a DCI format) in time domain, the UCI in the PUCCH is multiplexed in the second PUSCH including only one CW, and the multiplexed second PUSCH is transmitted. Or, if the UE is not configured with the fifth parameter, when the PUCCH overlaps with a PUSCH including N CWs and a second PUSCH including only one CW (e.g., PUSCH scheduled by a DCI format) in time domain, the UE does not transmit the PUCCH, and transmits the PUSCH including N CWs.

In some implementations, it may be indicated by the sixth parameter whether the UE can simultaneously transmit a PUSCH including N CWs with a PUCCH. For example, if the UE is configured with the sixth parameter, when a PUCCH overlaps with a PUSCH including N CWs in time domain, the UE simultaneously transmits the PUCCH and the PUSCH.

Each of the fifth parameter or the sixth parameter may be configured separately for each serving cell, or separately for each PUCCH group, or separately for each BWP, or in a PUSCH configuration parameter (e.g., PUSCH-Config).

The UE may report or indicate a capability to support the multiplexing of UCI (e.g., HARQ-ACK and/or CSI) of a PUCCH in a PUSCH including N CWs. For example, the base station may perform uplink (e.g., PUSCH) scheduling based on the capability reported or indicated by the UE. The method can enable the base station to perform the uplink scheduling according to the capability of the UE, and avoid the base station from scheduling transmission modes that are not supported by the UE, thereby improving the reliability of uplink transmission.

In some implementations, it may be dynamically indicated in a DCI whether UCI can be multiplexed in a PUSCH including N CWs, and/or whether a PUCCH can be simultaneously transmitted with a PUSCH including N CWs. The manner can be enabled by a higher layer signaling configuration. The method can improve the flexibility of the scheduling.

The method according to the manner MN2 can improve the flexibility of the configuration, thereby improving the performance of the uplink scheduling.

### Manner MN3

According to some embodiments of manner MN3, the UE may be configured or provided with a configuration indicating whether the UE can multiplex UCI in a PUSCH including one CW or N (N is an integer greater than 1, such as 2) CWs, and/or whether the UE can simultaneously transmit a PUSCH including one CW or N CWs with a PUCCH. For example, the UE may receive the configuration from the base station.

In some implementations, it may be indicated by a seventh parameter that the UE can multiplex UCI in one CW or N CWs of a PUSCH. For example, if the UE is configured with the seventh parameter to indicate the multiplexing of UCI in one CW of a PUSCH, when a PUCCH overlaps with the PUSCH including N CWs in time domain, the UE can multiplex the UCI (e.g., HARQ-ACK and/or CSI) included in the PUCCH in one CW of the PUSCH. If the UE is configured with the seventh parameter to indicate the multiplexing of UCI in N CWs of a PUSCH, when a PUCCH overlaps with the PUSCH including N CWs in time domain, the UE can multiplex the UCI (e.g., HARQ-ACK and/or CSI) included in the PUCCH in N CWs of the PUSCH. In some implementations, it may be indicated by an eighth parameter that the UE can multiplex UCI in N CWs of a PUSCH. For example, if the UE is configured with the eighth parameter, when a PUCCH overlaps with the PUSCH including N CWs in time domain, the UE can multiplex the UCI (e.g., HARQ-ACK and/or CSI) included in the PUCCH in N CWs of the PUSCH. If the UE is not configured with the eighth parameter, when a PUCCH overlaps with the PUSCH including N CWs in time domain, the UE can multiplex the UCI (e.g., HARQ-ACK and/or CSI) included in the PUCCH in one CW of the PUSCH.

In some implementations, it may be indicated by a ninth parameter that the UE can multiplex UCI in one CW of a PUSCH. For example, if the UE is configured with the ninth parameter, when a PUCCH overlaps with the PUSCH including N CWs in time domain, the UE can multiplex the UCI (e.g., HARQ-ACK and/or CSI) included in the PUCCH in one CW of the PUSCH. If the UE is not configured with the ninth parameter, when a PUCCH overlaps with the PUSCH including N CWs in time domain, the UE can multiplex the UCI (e.g., HARQ-ACK and/or CSI) included in the PUCCH in N CWs of the PUSCH.

Each of the seventh parameter, the eighth parameter or the ninth parameter may be configured separately for each serving cell, or separately for each PUCCH group, or separately for each BWP, or in a PUSCH configuration parameter (e.g., PUSCH-Config).

The UE may report or indicate a capability to support the multiplexing of UCI (e.g., HARQ-ACK and/or CSI) in one CW of a PUSCH including N CWs, and/or the UE may report or indicate a capability to support the multiplexing of UCI (e.g., HARQ-ACK and/or CSI) in N CWs of a PUSCH including N CWs. The method can enable the base station to perform uplink scheduling according to at least one of the capabilities reported or indicated by the UE, and avoid the base station from scheduling transmission modes that are not supported by the UE, thereby improving the reliability of uplink transmission.

The method according to manner MN3 can improve the flexibility of the configuration, thereby improving the performance of the uplink scheduling.

### Manner MN4

According to some embodiments of manner MN4, the UE may be configured or provided with a configuration for indicating a number or scale of resources on a PUSCH including N CWs that are allocated to UCI when the UCI is multiplexed in the PUSCH.

In some implementations, if the UE can multiplex UCI in a PUSCH including N CWs, a configuration parameter of the UCI in the PUSCH (e.g., uci-OnPUSCH) may be configured by a tenth parameter. The tenth parameter may be used to indicate a beta offset parameter (e.g., betaOffset, which may be selected from ‘dynamic’ or ‘semiStatic’) and/or a scaling parameter (e.g., scaling or alpha, which indicates a scaling factor limiting a number of resources (e.g., resource elements (REs)) on the PUSCH that are allocated to the UCI) by which the UCI is multiplexed in the PUSCH including N CWs. If the UE is configured with the tenth parameter, when the UE multiplexes UCI in a PUSCH including N CWs, the UE may determine a number of the REs occupied by the UCI according to the tenth parameter. If the UE is not configured with the tenth parameter, when the UE multiplexes a UCI in a PUSCH including N CWs, the UE may determine a number of the REs occupied by the UCI according to a configuration parameter of the UCI (e.g., uci-OnPUSCH, uci-OnPUSCH-ListDCI-0-1 or uci-OnPUSCH-ListDCI-0-2). The tenth parameter may include at least one of uci-OnPUSCH, uci-OnPUSCH-ListDCI-0-1 and uci-OnPUSCH-ListDCI-0-2.

In an example, the UE may be configured with a second uci-OnPUSCH, which is used to indicate the configuration parameter (e.g., the number or scale of resources on the PUSCH that are allocated to the UCI) of the UCI by which the UCI is multiplexed in the PUSCH including N CWs.

In an example, the UE may be configured with a second uci-OnPUSCH-ListDCI-0-1. The second uci-OnPUSCH-ListDCI-0-1 may include two uci-OnPUSCH, which respectively correspond to the configuration parameter (e.g., the number or scale of the resources on the PUSCH that are allocated to the UCI) of the UCI by which HARQ-ACK with a lower priority is multiplexed in the PUSCH including N CWs that is scheduled by a DCI format 0-1, and the configuration parameter by which HARQ-ACK with a higher priority is multiplexed in the PUSCH.

In an example, the UE may be configured with a second uci-OnPUSCH-ListDCI-0-2. The second uci-OnPUSCH-ListDCI-0-2 may include two uci-OnPUSCH-DCI-0-2, which respectively correspond to the configuration parameter (e.g., the number of the resources on the PUSCH that are allocated to the UCI) of the UCI by which HARQ-ACK with a lower priority is multiplexed in the PUSCH including N CWs that is scheduled by a DCI format 0-2, and the configuration parameter by which HARQ-ACK with a higher priority is multiplexed in the PUSCH.

The method according to manner MN4 can improve the flexibility of the scheduling by configuring the separate configuration parameters of the UCI, thereby improving the performance of the uplink scheduling.

When a PUSCH scheduled by a DCI format can include N (for example, N is an integer greater than 1, such as 2) CWs or TBs, it is necessary to clarify whether fields in the DCI are uniformly or separately indicated for N (e.g., 2) CWs. For example, it may be determined using manner MN5.

### Manner MN5

According to some embodiments of manner MN5, at least one of a modulation and coding scheme (MCS) field, a new data indicator (NDI) field, a redundancy version (RV) field, a priority indicator field, a DAI or beta offset (beta_offset) indicator field may be configured separately for each of N (e.g., 2) TBs in an uplink DCI format (e.g., DCI format 0-1 or DCI format 0-2).

In some implementations, the MCS field, and/or the NDI field, and/or the RV field may be configured separately for each of N (e.g., 2) TBs in the uplink DCI format (e.g., DCI format 0-1 or DCI format 0-2). This can improve the flexibility of the scheduling.

In some implementations, the priority indicator field may be configured separately for each of N (e.g., 2) TBs in the uplink DCI format (e.g., DCI format 0-1 or DCI format 0-2). In some cases, data with a higher priority may be smaller, and needs only one TB to be transmitted. At this time, it may be indicated that TBs with different priorities are transmitted in one PUSCH. In other cases, retransmission may be scheduled for data with a priority for which no new data needs to be transmitted. At this time, initial transmission may be scheduled for data with another priority, which can improve the flexibility of the scheduling.

In some implementations, the DAI field and/or the beta offset indicator field may be configured separately for each of N (e.g., 2) TBs in the uplink DCI format (e.g., DCI format 0-1 or DCI format 0-2). When the UCI (e.g., HARQ-ACK) is multiplexed in the PUSCH including N CWs or TBs, DAI information for HARQ-ACK multiplexed in each TB and/or beta_offset for HARQ-ACK/CSI may be indicated separately. This can improve the flexibility of the scheduling.

The UE may report or indicate a capability to support separate configuration of at least one of the MCS, NDI, RV, priority indicator, DAI or beta offset indicator in the DCI that schedules the PUSCH including N CWs. Whether at least one of the MCS, NDI, RV, priority indicator, DAI or beta offset indicator is indicated in the DCI separately for each of respective TBs may be configured by a higher layer parameter. For example, the base station may perform the configuration based on a capability reported or indicated by the UE. The method can enable the base station to perform uplink scheduling according to the capability reported or indicated by the UE, and avoid the base station from scheduling transmission modes that are not supported by the UE, thereby improving the reliability of uplink transmission.

In some cases, the UE may receive a DCI format to schedule a PUSCH including N (for example, N is an integer greater than 1, such as 2) CWs or TBs, and an NDI of each CW is toggled compared with an NDI indicated by a previous DCI format scheduling a PUSCH of the same HARQ process. At this time, each TB in the PUSCH scheduled by the DCI format is an initial transmission. It may be specified by protocols and/or configured by higher layer parameters to adopt at least one of manners MN6˜MN8 to generate a MAC PDU.

### Manner MN6

In some implementations, the UE first generates a MAC PDU (e.g., MAC PDU for a TB satisfying a first predefined condition), or generates a MAC PDU for a TB (e.g., TB satisfying the first predefined condition), or determines data of a MAC PDU (e.g., MAC SDUs included in the MAC PDU). After generating the MAC PDU or determining the data of the MAC PDU, if data in a buffer status report (BSR) is not 0 or there is data (e.g., data available for uplink transmission) for any logic channel (LC) or logic channel group (LCG), the UE generates another MAC PDU or determines data of another MAC PDU. Additionally or alternatively, after generating the MAC PDU or determining the data of the MAC PDU, if the data for the BSR is 0 or there is no data (e.g., data available for transmission) for any logic channel (LC) or logic channel group (LCG), the UE does not generate another MAC PDU, and transmits only one TB in the scheduled PUSCH, e.g., a TB corresponding to the generated MAC PDU. In this way, the transmission power of the UE can be reduced and the interference to other channels can be reduced.

For example, for a certain TB, the first predefined condition may include at least one of the following:
A condition that the TB is the first TB (or the last TB (i.e., the Nth TB), or the second TB).
A condition that the TB is of a higher priority.
A condition that the TB is with a higher (or lower) MCS.

### Manner MN7

In some implementations, the UE first generates one MAC PDU (e.g., a MAC PDU of a TB satisfying the first predefined condition described above), or generates a MAC PDU for one TB (e.g., a TB satisfying the first predefined condition described above), or determines data of one MAC PDU (e.g., a MAC SDU included in one MAC PDU). After generating the MAC PDU or determining the data of the MAC PDU, if the data for the BSR is 0 or there is no data for any LC or LCG, the UE generates another MAC PDU, which may be generated using padding bits (e.g., all 0s). When a PUCCH overlaps with a scheduled PUSCH in time domain, the UCI may be preferentially multiplexed in a TB satisfying a second predefined condition, which can improve the reliability of data transmission.

For example, for a certain TB, the second predefined condition may include at least one of the following:
A condition that the TB is the second TB or the last TB (i.e., the Nth TB) (or the TB is the first TB).
A condition that the TB is of a same priority as the PUCCH.
A condition that the TB is a TB with a lower (or higher) MCS level.

In some examples, the first predefined condition and the second predefined condition are associated with each other. As an example, for a certain TB, the first predefined condition may include at least one of the following: a condition that the TB is the first TB; a condition that the TB is of a higher priority; a condition that the TB is with a higher MCS, and the second predefined condition may include at least one of the following: a condition that the TB is the second TB or the last TB (i.e., the Nth TB); a condition that the TB is of a same priority as the PUCCH; a condition that the TB is with a lower MCS level. As another example, for a certain TB, the first predefined condition may include at least one of: a condition that the TB is the last TB (i.e., the Nth TB) or the second TB; a condition that the TB is of a higher priority; or a condition that the TB is with a lower MCS, and the second predefined condition may include at least one of the following: a condition that the TB is the first TB; a condition that the TB is of a same priority as the PUCCH; or the TB is with a higher MCS level.

### Manner MN8

In some implementations, the UE generates two MAC PDUs, in which data of a BSR (or logical channel) may be uniformly mapped. The method is simple to implement.

In some cases, the PUCCH may overlap with one or more PUSCHs in time domain. For example, the one or more PUSCHs may include a PUSCH including only one CW and a PUSCH including N (for example, N is an integer greater than 1, such as 2) CWs. At least one of manners MN9 to MN11 may be used to determine the PUSCH in which the UCI in the PUCCH is to be multiplexed.

### Manner MN9

In some implementations, if a PUCCH overlaps with both a PUSCH including only one CW and a PUSCH including N CWs in time domain, the UE can multiplex UCI of the PUCCH in the PUSCH including N CWs. This can improve the reliability of UCI transmission.

### Manner MN10

In some implementations, if a PUCCH overlaps with both a PUSCH including only one CW and a PUSCH including N CWs in time domain, the UE can multiplex UCI of the PUCCH in the PUSCH including one CW. This can improve the reliability of UCI transmission.

It should be noted that, in embodiments of the disclosure, the “PUSCH including N CWs” may be that the actually transmitted PUSCH includes N TBs or that the DCI scheduling the PUSCH indicates that the PUSCH includes N TBs.

It should be noted that, in embodiments of the disclosure, the scheme for the PUSCH including more than one TB may also be applicable to the scenario where more than one PUSCH is scheduled by one DCI format. The scheduling of more than one PUSCH may be scheduling of multiple PUSCHs of a same serving cell (for example, the UE is configured with multiple PUSCH time domain resource allocation list parameters, e.g., the parameter pusch-TimeDomainAllocationListForMultiPUSCH), and/or scheduling of multiple PUSCHs of different serving cells (for example, the UE is configured with PUSCH time domain resource allocation list parameters of multiple serving cells; for another example, the UE is configured with a parameter indicating that a DCI format is enabled to schedule PUSCHs of more than one serving cell). For example, the “PUSCH including more than one TB” in embodiments of the disclosure may be replaced by a “PUSCH scheduled by a DCI format scheduling more than one PUSCH”. The “DCI format scheduling more than one PUSCH” may be understood as a DCI format by which a number of PUSCHs actually scheduled (or PUSCHs nominally scheduled, which, for example, may be PUSCHs indicated in the DCI format) is more than one and/or a DCI format by which a number of PUSCHs that can be scheduled is more than one. For another example, the “TB” in embodiments of the disclosure, for example, the TB in manner MN5, may be replaced by the “PUSCH”.

FIG. 7 illustrates a flowchart of a method 700 performed by a terminal according to an embodiment of the disclosure.

Referring to FIG. 7, in operation S710, the terminal determines whether UCI is multiplexed in a first PUSCH including more than one transport block and/or whether the first PUSCH is simultaneously transmitted with a PUCCH including the UCI.

Continuing to refer to FIG. 7, in operation S720, the terminal receives information for scheduling transmission of the first PUSCH.

Next, in operation S730, the terminal transmits the first PUSCH and/or the PUCCH including the UCI based on the determination in operation S710.

In some implementations, for example, the transmitting of the first PUSCH and/or the PUCCH including the UCI based on the determination may include at least one of:
in case of determining that the UCI is multiplexed in the first PUSCH including more than one transport block, when the PUCCH overlaps with the first PUSCH in time domain, multiplexing the UCI of the PUCCH in the first PUSCH, and transmitting the multiplexed PUSCH;
in case of determining that the UCI is not multiplexed in the first PUSCH including more than one transport block, when the PUCCH overlaps with the first PUSCH in time domain, transmitting the PUCCH and/or not transmitting the first PUSCH;
in case of determining that the UCI is not multiplexed in the first PUSCH including more than one transport block, when the PUCCH does not overlap with any second PUSCH including one transport block in time domain, transmitting the PUCCH and/or not transmitting the first PUSCH including more than one transport block;
in case of determining that the UCI is not multiplexed in the first PUSCH including more than one transport block, when the PUCCH overlaps with a second PUSCH including one transport block in time domain, multiplexing the UCI of the PUCCH in the second PUSCH including one transport block, and transmitting the multiplexed second PUSCH and/or transmitting the first PUSCH including more than one transport block;
in case of determining that the UCI is not multiplexed in the first PUSCH including more than one transport block, when the PUCCH overlaps with the first PUSCH in time domain, simultaneously transmitting the PUCCH and the first PUSCH;
in case of determining that the UCI is not multiplexed in the first PUSCH including more than one transport block, when the PUCCH overlaps with the first PUSCH in a same serving cell in time domain, transmitting the PUCCH and/or not transmitting the first PUSCH;
in case of determining that the UCI is not multiplexed in the first PUSCH including more than one transport block, when the PUCCH overlaps with the first PUSCH in a different serving cell in time domain, simultaneously transmitting the PUCCH and the first PUSCH;
in case of determining that the first PUSCH is simultaneously transmitted with the PUCCH including the UCI, when the PUCCH overlaps with the first PUSCH in time domain, simultaneously transmitting the PUCCH and the first PUSCH; or
in case of determining that the first PUSCH is not simultaneously transmitted with the PUCCH including the UCI, when the PUCCH overlaps with the first PUSCH in time domain, transmitting the PUCCH and/or not transmitting the first PUSCH.

In some implementations, for example, the determining of whether the UCI is multiplexed in the first PUSCH including more than one transport block and/or whether the first PUSCH is simultaneously transmitted with the PUCCH including the UCI may include: receiving a first configuration indicating whether the UCI can be multiplexed in the first PUSCH including more than one transport block and/or whether the first PUSCH can be simultaneously transmitted with the PUCCH including the UCI; and determining whether the UCI can be multiplexed in the first PUSCH including more than one transport block and/or whether the first PUSCH can be simultaneously transmitted with the PUCCH including the UCI based on the first configuration.

In some implementations, for example, the first configuration may indicate that the UCI can be multiplexed in the first PUSCH including more than one transport block; and/or the first configuration may indicate that the first PUSCH including more than one transport block can be simultaneously transmitted with the PUCCH including the UCI; and/or the first configuration may indicate that the UCI can be multiplexed in one of the more than one transport block included in the first PUSCH; and/or the first configuration may indicate that the UCI can be multiplexed in all of the more than one transport block included in the first PUSCH; and/or the first configuration may indicate that the UCI can be multiplexed in at least one of the more than one transport block included in the first PUSCH.

In some implementations, for example, the method may further include: transmitting a capability indication including at least one of: an indication that the terminal can multiplex the UCI in the first PUSCH including more than one transport block, an indication that the terminal can multiplex the UCI in one of the more than one transport block included in the first PUSCH, an indication that the terminal can multiplex the UCI in all of the more than one transport block included in the first PUSCH, or an indication that the terminal can multiplex the UCI in at least one of the more than one transport block included in the first PUSCH. The information for scheduling transmission of the first PUSCH may be transmitted based on the capability indication.

In some implementations, for example, the method may further include: receiving a second configuration indicating a maximum number of transport blocks included in a PUSCH.

In some implementations, for example, in case that the UCI can be multiplexed in the first PUSCH including more than one transport block, the method may further include receiving a third configuration which may indicate a number or scale of resources on the first PUSCH that are allocated for UCI multiplexing in the first PUSCH.

In some implementations, for example, the receiving of the information for scheduling transmission of the first PUSCH may include: receiving downlink control information (DCI) for scheduling the first PUSCH, wherein the DCI indicates at least one of a modulation and coding scheme (MCS) field, a new data indicator field, a redundancy version field, a priority indicator field, a DAI field, a beta offset indicator field separately for each of the more than one transport block.

In some implementations, for example, the receiving of the information for scheduling transmission of the first PUSCH may include: receiving a DCI for scheduling the first PUSCH including a first transport block and a second transport block. The transmitting of the first PUSCH and/or the PUCCH including the UCI may include: generating a first MAC PDU for the first transport block based on data in one or more logical channels (LCs) or logical channel groups (LCGs), and transmitting only the first transport block in the first PUSCH in case that all of the one or more LCs or all of the one or more LCGs have no data available for transmission after the first MAC PDU is generated.

In some implementations, for example, the receiving of the information for scheduling transmission of the first PUSCH may include: receiving a DCI for scheduling the first PUSCH including a first transport block and a second transport block. The transmitting of the first PUSCH and/or the PUCCH including the UCI includes: generating a first MAC PDU for the first transport block based on data in one or more LCs or one or more LCGs, and generating a second MAC PDU for the second transport block by using one or more padding bits in case that all of the one or more LCs or all of the one or more LCGs have no data available for transmission after the first MAC PDU is generated, and transmitting the first transport block and the second transport block in the first PUSCH.

In some implementations, for example, an index of the first transport block may be smaller than that of the second transport block; and/or a priority of the first transport block may be higher than that of the second transport block; and/or an MCS level of the first transport block may be higher than that of the second transport block.

In some implementations, for example, the receiving of the information for scheduling transmission of the first PUSCH may include: receiving a DCI for scheduling the first PUSCH including a first transport block and a second transport block. The transmitting of the first PUSCH and/or the PUCCH including the UCI may include: generating a first MAC PDU and a second MAC PDU based on one or more data available for transmission in one or more LCs or one or more LCGs so that the one or more data available for transmission are uniformly included in the first MAC PDU and the second MAC PDU, and transmitting the first MAC PDU and the second MAC PDU in the first PUSCH by using the first transport block and the second transport block.

In some implementations, for example, in case of determining that the UCI is multiplexed in the first PUSCH including more than one transport block, when the PUCCH overlaps with the first PUSCH in time domain, the second transport block may be prioritized for the multiplexing of the UCI over the first transport block.

In some implementations, for example, the method may further include receiving information for scheduling transmission of a second PUSCH including one transport block. The transmitting of the first PUSCH and/or the PUCCH including the UCI based on the determination includes: in case of determining that the UCI is multiplexed in the first PUSCH including more than one transport block, when the PUCCH overlaps with the second PUSCH including one transport block and the first PUSCH including more than one transport block in time domain at the same time, multiplexing the UCI in the PUCCH in the first PUSCH including more than one transport block, and transmitting the second PUSCH and the multiplexed PUSCH.

In some implementations, for example, the method may further include receiving information for scheduling transmission of a second PUSCH including one transport block. The transmitting of the first PUSCH and/or the PUCCH including the UCI based on the determination may include: in case of determining that the UCI is multiplexed in the first PUSCH including more than one transport block, when the PUCCH overlaps with the second PUSCH including one transport block and the first PUSCH including more than one transport block in time domain at the same time, multiplexing the UCI of the PUCCH in the second PUSCH including one transport block, and transmitting the first PUSCH and the multiplexed second PUSCH.

In some implementations, for example, the information for scheduling transmission of the first PUSCH may include at least one of a configured uplink grant or DCI. For example, the first PUSCH may be a dynamically scheduled PUSCH or a CG PUSCH. For example, the second PUSCH may be a dynamically scheduled PUSCH or a CG PUSCH.

In some implementations, operations 5710 and/or S720 and/or S730 may be performed based on the methods described according to various embodiments (e.g., various manners described above, such as manners MN1-MN10) of the disclosure.

In some implementations, the method 700 may omit one or more of operation S710, operation S720 or operation S730, or may include additional operations, for example, the operations performed by the terminal (e.g., a UE) that are described according to various embodiments (e.g., various manners described above, such as manners MN1-MN10) of the disclosure.

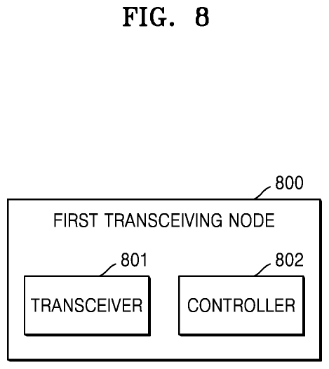

FIG. 8 illustrates a block diagram of a first transceiving node 800 according to an embodiment of the disclosure.

Referring to FIG. 8, the first transceiving node 800 may include a transceiver 801 and a controller 802.

The transceiver 801 may be configured to transmit first data and/or first control signaling to a second transceiving node and receive second data and/or second control signaling from the second transceiving node in a time unit.

The controller 802 may be an application specific integrated circuit or at least one processor. The controller 802 may be configured to control the overall operation of the first transceiving node, including controlling the transceiver 801 to transmit the first data and/or the first control signaling to the second transceiving node and receive the second data and/or the second control signaling from the second transceiving node in a time unit.

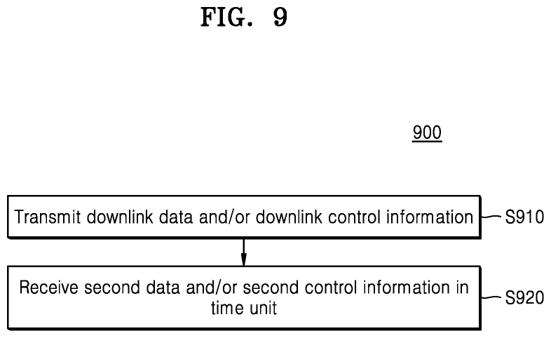

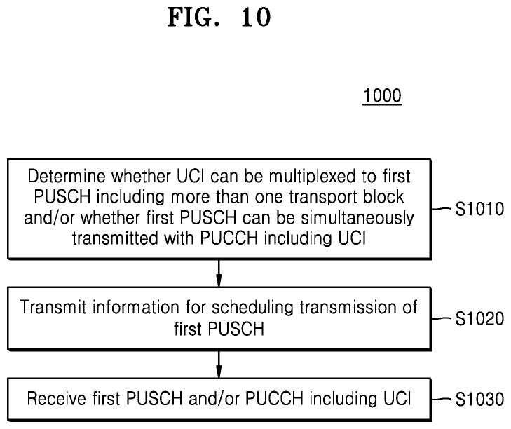

In some implementations, the controller 802 may be configured to perform one or more of the operations in the methods of various embodiments described above, for example, the operations in the method to be described in connection with FIG. 9, the operations in the method to be described in connection with FIG. 10, and/or the operations performed by a base station that are described according to various embodiments (e.g., manners MN1-MN7) of the disclosure.

In the following description, a base station is taken as an example (but not limited thereto) to illustrate the first transceiving node, a UE is taken as an example (but not limited thereto) to illustrate the second transceiving node. Downlink data and/or downlink control signaling (but not limited thereto) are used to illustrate the first data and/or the first control signaling. A HARQ-ACK codebook may be included in the second control signaling, and uplink control signaling (but not limited thereto) is used to illustrate the second control signaling.

FIG. 9 illustrates a flowchart of a method 900 performed by a base station according to an embodiment of the disclosure.

Referring to FIG. 9, in operation S910, the base station transmits downlink data and/or downlink control information.

In operation S920, the base station receives second data and/or second control information from a UE in a time unit.

For example, the method 900 may include one or more of the operations performed by the base station that are described in various embodiments (e.g., manners MN1-MN7) of the disclosure.

FIG. 10 illustrates a flowchart of a method 1000 performed by a base station according to an embodiment of the disclosure.

Referring to FIG. 10, in operation S1010, the base station determines whether UCI can be multiplexed in a first PUSCH including more than one transport block and/or whether the first PUSCH can be simultaneously transmitted with a PUCCH including the UCI.

In operation S1020, the base station transmits information for scheduling transmission of the first PUSCH.

Next, in operation S1030, the base station receives the first PUSCH and/or the PUCCH including the UCI.

In some implementations, for example, the information for scheduling transmission of the first PUSCH may include at least one of a configured uplink grant or DCI. For example, the first PUSCH may be a dynamically scheduled PUSCH or a CG PUSCH. For example, the second PUSCH may be a dynamically scheduled PUSCH or a CG PUSCH.

In some implementations, operations S1010 and/or S1020 and/or S1030 may be performed based on the methods described according to various embodiments (e.g., various manners described above, such as manners MN1-MN10) of the disclosure.

In some implementations, the method 1000 may omit one or more of operation S1010, S1020 or S1030, or may include additional operations, for example, the operations performed by the base station that are described according to various embodiments (e.g., various manners described above, such as manners MN1-MN10) of the disclosure.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, erasable programmable ROM (EPROM) memory, electrically EPROM (EEPROM) memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been shown and described with reference to various embodiments thereof, it will be understood by those skilled in the art that various changes in form and details may be made therein without departing from the spirit and scope of the disclosure as defined by the appended claims and their equivalents.

In accordance with an aspect of the disclosure, a method performed by a terminal in a wireless communication system is provided. The method includes determining whether uplink control information (UCI) is multiplexed in a first physical uplink shared channel (PUSCH) including more than one transport block (TB) or whether the first PUSCH is simultaneously transmitted with a physical uplink control channel (PUCCH) including the UCI, receiving information for scheduling transmission of the first PUSCH, and transmitting the first PUSCH or the PUCCH including the UCI based on the determination.

In accordance with another aspect of the disclosure, a method performed by a base station in a wireless communication system is provided. The method includes determining whether uplink control information (UCI) can be multiplexed in a first physical uplink shared channel (PUSCH) including more than one transport block or whether the first PUSCH can be simultaneously transmitted with a PUCCH including the UCI, transmitting information for scheduling transmission of the first PUSCH, and receiving the first PUSCH or the PUCCH including the UCI.

In some implementations, for example, in case that the UCI is determined to be multiplexed in the first PUSCH including more than one transport block, when the PUCCH overlaps with the first PUSCH in a time domain, the UCI in the PUCCH is multiplexed in the first PUSCH, and the multiplexed first PUSCH is transmitted, or in case that the UCI is determined not to be multiplexed in the first PUSCH including more than one transport block, when the PUCCH overlaps with the first PUSCH in the time domain, the PUCCH is transmitted or the first PUSCH is not transmitted, or in case that the UCI is determined not to be multiplexed in the first PUSCH including more than one transport block, when the PUCCH does not overlap with any second PUSCH including one transport block in the time domain, the PUCCH is transmitted or the first PUSCH is not transmitted, or in case that the UCI is determined not to be multiplexed in the first PUSCH including more than one transport block, when the PUCCH overlaps with a second PUSCH including one transport block in the time domain, the UCI in the PUCCH is multiplexed in the second PUSCH including one transport block, and the multiplexed second PUSCH or the first PUSCH is transmitted, or in case that the UCI is determined not to be multiplexed in the first PUSCH including more than one transport block, when the PUCCH overlaps with the first PUSCH in the time domain, the PUCCH and the first PUSCH are simultaneously transmitted, or in case that the UCI is determined not to be multiplexed in the first PUSCH including more than one transport block, when the PUCCH overlaps with the first PUSCH in a same serving cell in the time domain, the PUCCH is transmitted or the first PUSCH is not transmitted, or in case that the UCI is determined not to be multiplexed in the first PUSCH including more than one transport block, when the PUCCH overlaps with the first PUSCH in a different serving cell in the time domain, the PUCCH and the first PUSCH are simultaneously transmitted, or in case that the first PUSCH is determined to be simultaneously transmitted with the PUCCH including the UCI, when the PUCCH overlaps with the first PUSCH in the time domain, the PUCCH and the first PUSCH are simultaneously transmitted, or in case that the first PUSCH is determined not to be simultaneously transmitted with the PUCCH including the UCI, when the PUCCH overlaps with the first PUSCH in the time domain, the PUCCH is transmitted or the first PUSCH is not transmitted.

In some implementations, for example, the method further includes transmitting, to a terminal, a first configuration indicating whether the UCI can be multiplexed in the first PUSCH including more than one transport block or whether the first PUSCH can be simultaneously transmitted with the PUCCH including the UCI.

In some implementations, for example, the first configuration indicates that the UCI can be multiplexed in the first PUSCH including more than one transport block, or the first configuration indicates that the first PUSCH including more than one transport block can be simultaneously transmitted with the PUCCH including the UCI, or the first configuration indicates that the UCI can be multiplexed in one of the more than one transport block included in the first PUSCH, or the first configuration indicates that the UCI can be multiplexed in all of the more than one transport block included in the first PUSCH, or the first configuration indicates that the UCI can be multiplexed in one or all of the more than one transport block included in the first PUSCH.

In some implementations, for example, the determining of whether the UCI can be multiplexed in the first PUSCH including more than one transport block or whether the first PUSCH can be simultaneously transmitted with the PUCCH including the UCI includes receiving, from a terminal, a capability indication including at least one of an indication that the terminal can multiplex the UCI in the first PUSCH including more than one transport block, an indication that the terminal can multiplex the UCI in one of the more than one transport block included in the first PUSCH, an indication that the terminal can multiplex the UCI in all of the more than one transport block included in the first PUSCH, or an indication that the terminal can multiplex the UCI in one or all of the more than one transport block included in the first PUSCH, and determining, based on the capability indication, whether the UCI can be multiplexed in the first PUSCH including more than one transport block or whether the first PUSCH can be simultaneously transmitted with the PUCCH including the UCI.

In some implementations, for example, the method further includes transmitting, to a terminal, a second configuration indicating a maximum number of transport blocks included in the first PUSCH.

In some implementations, for example, in case that the UCI can be multiplexed in the first PUSCH including more than one transport block, the method further includes transmitting, to a terminal, a third configuration indicating a number or scale of resources on the first PUSCH that are allocated for UCI multiplexing in the first PUSCH.

In some implementations, for example, the transmitting of the information for scheduling transmission of the first PUSCH includes transmitting downlink control information (DCI) for scheduling the first PUSCH. The DCI indicates at least one of a modulation and coding scheme (MCS) field, a new data indicator field, a redundancy version field, a priority indicator field, a downlink assignment indicator (DAI) field, a beta offset indicator field separately for each of the more than one transport block.

In some implementations, for example, the method further includes transmitting information for scheduling transmission of a second PUSCH including one transport block. The receiving of the first PUSCH or the PUCCH including the UCI includes in case that the UCI is determined to be multiplexed in the first PUSCH including more than one transport block, when the PUCCH overlaps with both the second PUSCH including one transport block and the first PUSCH including more than one transport block in the time domain, receiving the second PUSCH and a multiplexed PUSCH obtained by multiplexing of the UCI in the PUCCH in the first PUSCH.

In some implementations, for example, the method further includes transmitting information for scheduling transmission of a second PUSCH including one transport block. The receiving of the first PUSCH or the PUCCH including the UCI includes in case that the UCI is determined to be multiplexed in the first PUSCH including more than one transport block, when the PUCCH overlaps with both the second PUSCH including one transport block and the first PUSCH including more than one transport block in the time domain, receiving the first PUSCH and a multiplexed second PUSCH obtained by multiplexing of the UCI of the PUCCH in the second PUSCH including one transport block.

In accordance with another aspect of the disclosure, a terminal in a wireless communication system is provided. The terminal includes a transceiver, and at least one processor coupled to the transceiver and configured to determine whether uplink control information (UCI) is multiplexed in a first physical uplink shared channel (PUSCH) including more than one transport block (TB) or whether the first PUSCH is simultaneously transmitted with a PUCCH including the UCI, receiving information for scheduling transmission of the first PUSCH, and transmitting the first PUSCH or the PUCCH including the UCI based on the determination.

In accordance with another aspect of the disclosure, a base station in a wireless communication system is provided. The base station includes a transceiver, and at least one processor coupled to the transceiver and configured to determine whether UCI can be multiplexed in a first PUSCH including more than one transport block or whether the first PUSCH can be simultaneously transmitted with a PUCCH including the UCI, transmitting information for scheduling transmission of the first PUSCH, and receiving the first PUSCH or the PUCCH including the UCI.

In accordance with another aspect of the disclosure, a computer-readable storage medium having one or more computer programs stored thereon is provided. The one or more computer programs, when executed by one or more processors, can implement any of the above-described methods.

Other aspects, advantages, and salient features of the disclosure will become apparent to those skilled in the art from the following detailed description, which, taken in conjunction with the annexed drawings, discloses various embodiments of the disclosure.

What is claimed is:

1. A method performed by a terminal in a wireless communication system, the method comprising:
determining whether uplink control information (UCI) is multiplexed in a first physical uplink shared channel (PUSCH) including more than one transport block or whether the first PUSCH is simultaneously transmitted with a physical uplink control channel (PUCCH) including the UCI;
receiving information for scheduling transmission of the first PUSCH; and
transmitting the first PUSCH or the PUCCH including the UCI based on the determination.

2. The method of claim 1, wherein the transmitting of the first PUSCH or the PUCCH including the UCI based on the determination includes at least one of:
in case of determining that the UCI is multiplexed in the first PUSCH including more than one transport block, when the PUCCH overlaps with the first PUSCH in a time domain, multiplexing the UCI of the PUCCH in the first PUSCH, and transmitting the multiplexed first PUSCH;
in case of determining that the UCI is not multiplexed in the first PUSCH including more than one transport block, when the PUCCH overlaps with the first PUSCH in the time domain, transmitting the PUCCH;
in case of determining that the UCI is not multiplexed in the first PUSCH including more than one transport block, when the PUCCH does not overlap with any second PUSCH including one transport block in the time domain, transmitting the PUCCH;
in case of determining that the UCI is not multiplexed in the first PUSCH including more than one transport block, when the PUCCH overlaps with a second PUSCH including one transport block in the time domain, multiplexing the UCI of the PUCCH in the second PUSCH including one transport block, and transmitting the multiplexed second PUSCH or transmitting the first PUSCH including more than one transport block;
in case of determining that the UCI is not multiplexed in the first PUSCH including more than one transport block, when the PUCCH overlaps with the first PUSCH in the time domain, simultaneously transmitting the PUCCH and the first PUSCH;
in case of determining that the UCI is not multiplexed in the first PUSCH including more than one transport block, when the PUCCH overlaps with the first PUSCH in a same serving cell in the time domain, transmitting the PUCCH;
in case of determining that the UCI is not multiplexed in the first PUSCH including more than one transport block, when the PUCCH overlaps with the first PUSCH in a different serving cell in the time domain, simultaneously transmitting the PUCCH and the first PUSCH;
in case of determining that the first PUSCH is simultaneously transmitted with the PUCCH including the UCI, when the PUCCH overlaps with the first PUSCH in the time domain, simultaneously transmitting the PUCCH and the first PUSCH; or
in case of determining that the first PUSCH is not simultaneously transmitted with the PUCCH including the UCI, when the PUCCH overlaps with the first PUSCH in the time domain, transmitting the PUCCH.

3. The method of claim 1, wherein the determining of whether the UCI is multiplexed in the first PUSCH including more than one transport block or whether the first PUSCH is simultaneously transmitted with the PUCCH including the UCI includes:
receiving a first configuration indicating whether the UCI can be multiplexed in the first PUSCH including more than one transport block or whether the first PUSCH can be simultaneously transmitted with the PUCCH including the UCI; and
determining whether the UCI can be multiplexed in the first PUSCH including more than one transport block or whether the first PUSCH can be simultaneously transmitted with the PUCCH including the UCI based on the first configuration.

4. The method of claim 1, further comprising:
transmitting a capability indication including at least one of:
an indication that the terminal can multiplex the UCI in the first PUSCH including more than one transport block,
an indication that the terminal can multiplex the UCI in one of the more than one transport block included in the first PUSCH,
an indication that the terminal can multiplex the UCI in all of the more than one transport block included in the first PUSCH, or
an indication that the terminal can multiplex the UCI in at least one of the more than one transport block included in the first PUSCH,
wherein the information for scheduling transmission of the first PUSCH is transmitted based on the capability indication.

5. The method of claim 1, further comprising:
receiving a second configuration indicating a maximum number of transport blocks included in a PUSCH.

6. The method of claim 1, wherein in case that the UCI can be multiplexed in the first PUSCH including more than one transport block, the method further comprises receiving a third configuration indicating a number or scale of resources on the first PUSCH that are allocated for UCI multiplexing in the first PUSCH.

7. The method of claim 1,
wherein the receiving of the information for scheduling transmission of the first PUSCH includes receiving downlink control information (DCI) for scheduling the first PUSCH, and
wherein the DCI indicates at least one of a modulation and coding scheme (MCS) field, a new data indicator field, a redundancy version field, a priority indicator field, a downlink assignment indicator (DAI) field, a beta offset indicator field separately for each of the more than one transport block.

8. The method of claim 1,
wherein the receiving of the information for scheduling transmission of the first PUSCH includes receiving a DCI for scheduling the first PUSCH including a first transport block and a second transport block, and
wherein the transmitting of the first PUSCH or the PUCCH including the UCI includes:
generating a first medium access control (MAC) protocol data unit (PDU) for the first transport block based on data in one or more logical channels (LCs) or logical channel groups (LCGs), and
transmitting only the first transport block in the first PUSCH, in case that there is no data available for transmission for any of the one or more LCs or any of the one or more LCGs after the first MAC PDU is generated.

9. The method of claim 1,
wherein the receiving of the information for scheduling transmission of the first PUSCH includes receiving a DCI for scheduling the first PUSCH including a first transport block and a second transport block, and
wherein the transmitting of the first PUSCH or the PUCCH including the UCI includes:
generating a first MAC PDU for the first transport block based on data in one or more LCs or one or more LCGs,
generating a second MAC PDU for the second transport block by using one or more padding bits, in case that there is no data available for transmission for any of the one or more LCs or any of the one or more LCGs after the first MAC PDU is generated, and
transmitting the first transport block and the second transport block in the first PUSCH.

10. The method of claim 1,
wherein the receiving of the information for scheduling transmission of the first PUSCH includes receiving a DCI for scheduling the first PUSCH including a first transport block and a second transport block, and
wherein the transmitting of the first PUSCH or the PUCCH including the UCI includes:
generating a first MAC PDU and a second MAC PDU based on one or more data available for transmission for one or more LCs or one or more LCGs, so that the one or more data available for transmission are uniformly included in the first MAC PDU and the second MAC PDU, and
transmitting the first MAC PDU and the second MAC PDU in the first PUSCH by using the first transport block and the second transport block.

11. The method of claim 1, further comprising:
receiving information for scheduling transmission of a second PUSCH including one transport block,
wherein the transmitting of the first PUSCH or the PUCCH including the UCI based on the determination includes:
in case of determining that the UCI is multiplexed in the first PUSCH including more than one transport block, when the PUCCH overlaps with both the second PUSCH including one transport block and the first PUSCH including more than one transport block in a time domain, multiplexing the UCI of the PUCCH in the first PUSCH including more than one transport block, and
transmitting the second PUSCH and the multiplexed first PUSCH.

12. The method of claim 1, further comprising:
receiving information for scheduling transmission of a second PUSCH including one transport block,
wherein the transmitting of the first PUSCH or the PUCCH including the UCI based on the determination includes:
in case of determining that the UCI is multiplexed in the first PUSCH including more than one transport block, when the PUCCH overlaps with both the second PUSCH including one transport block and the first PUSCH including more than one transport block in a time domain, multiplexing the UCI of the PUCCH in the second PUSCH including one transport block, and
transmitting the first PUSCH and the multiplexed second PUSCH.

13. The method of claim 1, wherein the information for scheduling transmission of the first PUSCH includes at least one of a configured uplink grant or DCI.

14. A terminal in a wireless communication system, the terminal comprising:
a transceiver; and
a controller coupled to the transceiver and configured to:
determine whether uplink control information (UCI) is multiplexed in a first physical uplink shared channel (PUSCH) including more than one transport block or whether the first PUSCH is simultaneously transmitted with a physical uplink control channel (PUCCH) including the UCI,
receive information for scheduling transmission of the first PUSCH, and
transmit the first PUSCH or the PUCCH including the UCI based on the determination.

15. The terminal of claim 14, wherein the controller is further configured to:
in case of determining that the UCI is multiplexed in the first PUSCH including more than one transport block, when the PUCCH overlaps with the first PUSCH in a time domain, multiplex the UCI of the PUCCH in the first PUSCH, and transmit the multiplexed first PUSCH;
in case of determining that the UCI is not multiplexed in the first PUSCH including more than one transport block, when the PUCCH overlaps with the first PUSCH in the time domain, transmit the PUCCH;
in case of determining that the UCI is not multiplexed in the first PUSCH including more than one transport block, when the PUCCH does not overlap with any second PUSCH including one transport block in the time domain, transmit the PUCCH;
in case of determining that the UCI is not multiplexed in the first PUSCH including more than one transport block, when the PUCCH overlaps with a second PUSCH including one transport block in the time domain, multiplex the UCI of the PUCCH in the second PUSCH including one transport block, and transmit the multiplexed second PUSCH or transmitting the first PUSCH including more than one transport block;
in case of determining that the UCI is not multiplexed in the first PUSCH including more than one transport block, when the PUCCH overlaps with the first PUSCH in the time domain, simultaneously transmit the PUCCH and the first PUSCH;
in case of determining that the UCI is not multiplexed in the first PUSCH including more than one transport block, when the PUCCH overlaps with the first PUSCH in a same serving cell in the time domain, transmit the PUCCH;
in case of determining that the UCI is not multiplexed in the first PUSCH including more than one transport block, when the PUCCH overlaps with the first PUSCH in a different serving cell in the time domain, simultaneously transmit the PUCCH and the first PUSCH;
in case of determining that the first PUSCH is simultaneously transmitted with the PUCCH including the UCI, when the PUCCH overlaps with the first PUSCH in the time domain, simultaneously transmit the PUCCH and the first PUSCH; or
in case of determining that the first PUSCH is not simultaneously transmitted with the PUCCH including the UCI, when the PUCCH overlaps with the first PUSCH in the time domain, transmit the PUCCH.

16. The terminal of claim 14, wherein the controller is further configured to:
receive a first configuration indicating whether the UCI can be multiplexed in the first PUSCH including more than one transport block or whether the first PUSCH can be simultaneously transmitted with the PUCCH including the UCI,
receive a second configuration indicating a maximum number of transport blocks included in a PUSCH, and
in case that the UCI can be multiplex in the first PUSCH including more than one transport block, receive a third configuration indicating a number or scale of resources on the first PUSCH that are allocated for UCI multiplexing in the first PUSCH.

17. The terminal of claim 14,
wherein the controller is further configured to:
receive downlink control information (DCI) for scheduling the first PUSCH, and
wherein the DCI indicates at least one of a modulation and coding scheme (MCS) field, a new data indicator field, a redundancy version field, a priority indicator field, a downlink assignment indicator (DAI) field, a beta offset indicator field separately for each of the more than one transport block.

18. The terminal of claim 14, wherein the controller is further configured to:
receive a DCI for scheduling the first PUSCH including a first transport block and a second transport block;
generate a first medium access control (MAC) protocol data unit (PDU) and a second MAC PDU based on one or more data available for transmission for one or more logical channels (LCs) or one or more logical channel groups (LCGs), so that one or more data available for transmission are uniformly included in the first MAC PDU and the second MAC PDU; and
transmit the first MAC PDU and the second MAC PDU in the first PUSCH by using the first transport block and the second transport block.

19. A method performed by a base station in a wireless communication system, the method comprising:
determining whether uplink control information (UCI) can be multiplexed in a first physical uplink shared channel (PUSCH) including more than one transport block or whether the first PUSCH can be simultaneously transmitted with a physical uplink control channel (PUCCH) including the UCI;
transmitting information for scheduling transmission of the first PUSCH; and
receiving the first PUSCH or the PUCCH including the UCI.

20. A base station in a wireless communication system, the base station comprising:
a transceiver; and
a controller coupled to the transceiver and configured to:
determine whether uplink control information (UCI) can be multiplexed in a first physical uplink shared channel (PUSCH) including more than one transport block or whether the first PUSCH can be simultaneously transmitted with a physical uplink control channel (PUCCH) including the UCI,
transmit information for scheduling transmission of the first PUSCH, and
receive the first PUSCH or the PUCCH including the UCI.
